(19) United States
(12) Patent Application Publication
(10) Pub. No.: US 2002/0047430 A1
(43) Pub. Date: Apr. 25, 2002

(54) Motor

(75) Inventors: Shinichiroh Iwasaki, Aichi-ken (JP); Akinori Hoshino, Aichi-ken (JP); Takeshi Ikeyama, Aichi-ken (JP); Akemi Okawa, Aichi-ken (JP)

Correspondence Address: SUGHRUE MION ZINN MACPEAK & SEAS, PLLC, 2100 Pennsylvania Avenue, N.W., Washington, DC, 20037-3213, US

(73) Assignee: AISIN SEIKI KABUSHIKI KAISHA

(21) Appl. No.: 09/882,054

(22) Filed: Jun. 18, 2001

(30) Foreign Application Priority Data
Jun. 16, 2000 (JP) 2000-181964
Dec. 27, 2000 (JP) 2000-398180

(51) Int. Cl. H02K 21/26; H02K 21/12

(52) U.S. Cl. 310/156.39; 310/154.23

(57) ABSTRACT

The present invention provides an SR motor in which magnetic pole utilization is improved by increasing an overlapping area between projecting poles. A stator 10 is provided at its outer peripheral surface with slots SR1 through SR12. Between two adjacent slots, each of poles S1 through S12 are defined. Each of coils Aa, Ab, ba, Bb, Ca, and Cb is wound along any two slots between which two other slots are placed such that the coils Aa, Ba, and Ca are in parallel to the coils Ab, Bb, and Cb, respectively. Along an inner peripheral surface of a rotor 20, a plurality of circumferentially spaced magnetically insulated pieces J1 through J8 formed of magnetic material are mounted. When each of the pieces J1 through J8 is in opposition to the two adjacent poles of the stator 10, each of the coils generates a closed-loop magnetic flux that passes through the magnetic material piece and the poles corresponding thereto, thereby producing a torque.

The present application is based on and claims priority under 35 U.S.C §119 with respect to Japanese Patent application Nos. 2000-181964 and 2000-398180 filed on Jun. 16, 2000 and Dec. 27, 2000 respectively, the entire contents of which are incorporated herein by reference.

### FIELD OF THE INVENTION

The present invention is directed to an electric motor and in particular to a motor of the switched reluctance type (hereinafter referred to as an SR motor).

### BACKGROUND OF THE INVENTION

Referring to FIG. 27. there is illustrated a radial directional cross-sectional view of a conventional SR motor. The conventional SR motor includes a stator (1) which is configured to a hollow cylindrical shape and a cylindrical rotor (2) which is accommodated co-axially in the stator (1) for rotation therein. This SR motor is in the form of a three phase SR motor which is configured such that the stator (1) and the rotor (2) include six stator poles Sa, Sb, Sc, Sd, Se, and Sf and four rotor poles Ra, Rh, Rc, and Rd, respectively. Each of the stator (1) and the rotor (2) is made up of a plurality of axially stacked magnetic material or silicon steel plates.

The stator (1) is configured to have six integral inwardly extending poles Sa, Sb, Sc, Sd, Se, and Sf in such a manner that an angular distance of 60 degrees is set between two adjacent poles. The poles Sa, Sb, Sc, Sd, Se, and Sf are provided with energization coils La, Lb, Lc, Ld, Le. and Lf, wound thereon respectively. The wiring arrangement of each of the energization coils La, Lb, Lc, Ld, Le, and Lf and a current flow direction are understood from the illustration in FIG. 27

On the other hand, the rotor 2 is configured to have four integral outwardly extending poles Ra, Rb, Rc, and Rd in such a manner that an angular distance of 90 degrees is set between two adjacent poles.

Referring next to FIG. 28, there is illustrated the principle of how the conventional SR motor which is illustrated in FIG. 27 operates together with its basic structure and windings. In FIG. 28, if a current is applied sequentially to coils I, II, and III depending on respective angular positions of the rotor 2, a magnetic flux is generated between the pole of the stator 1 and the pole of the rotor 2 which are in mutual opposition, which results in the pole of the rotor 2 being attracted to the corresponding or opposing energized pole of the stator 1, which causes the rotor 2 to rotate, thereby producing a torque.

The angular position of the rotor 2 is determined by a position sensor (not shown) which is secured to the rotor 2. A set of closed circles each of which is formed by a STATE \mathring{1}, a STATE \mathring{2}, and a STATE \mathring{3} constitutes one step

Referring to FIG. 29, there is illustrated a circuit diagram of a driving circuit which drives the conventional SR motor which is shown in FIG.27. In FIG. 29, three sub driver circuits are connected to the coils I (in series with I′), II (in series with II′), and III (in series with III′), respectively. In detail, an extreme end of each of the coils I, II, and III is connected with an anode of a diode D1 and a collector of a switching element or transistor S1, while an extreme end of the each of coils I′. II′, and III′ is connected to an emitter of a switching element or transistor S2 and a cathode of a diode D2. A collector of the switching element S2 and a cathode of the diode D1 are connected to a positive (+) side of a power supply P, while an emitter of the switching element S1 and an anode of the diode D2 are connected to a negative (−) side of the power supply P.

If both the switching element S2 and the switching element S1 become conductive or are turned on, a current begins to flow from the positive (+) side of the power supply P to the negative (−) side thereof by way of the switching element S2, the coils I and I′, and the a switching element S1.

Referring to FIG. 30, there is illustrated a graph which represents an inductance of the coil, the current flowing in the coil, and the motor generating torque per one phase. As apparent from the illustration in FIG. 30, if a specific pole of the stator 1 which is unaligned with a specific pole of the rotor 2 becomes closer thereto as the rotor 2 rotates, the coil inductance starts from its minimum value to increase. In concurrency with such a rotation of the rotor 2, a current is supplied to the coil to generate torque. When the specific pole of the stator 1 is brought into perfectly alignment with the specific pole of the rotor 2, the inductance becomes maximum value. Thereafter, as the specific pole of the rotor 2 moves away from the specific pole of the stator 2 which results from further rotation of the rotor 2, the inductance becomes smaller and terminates in minimum value when the distance between the specific poles of the respective stator 1 and rotor 2 reaches the maximum. This also appears at another unaligned position at which a specific pole of the stator 1 is unaligned with a specific pole of the rotor 2.

FIG. 31 illustrates a graph which represents a magnetization curve of an SR motor. In this graph, horizontal (X) and vertical (Y) axes indicate current to be supplied to the coil (i.e. winding current) and magnetic flux linkage passing through the coil, respectively. FIG. 25 indicates or reveals that the inductance, which is low when the distance between the specific poles of the respective stator 1 and rotor 2 reaches the maximum, increases as the pole of the rotor 2 approaches the pole of the stator 1. After the inductance reaches the maximum or the peaked, which is due to the magnetic saturation of steel, the characteristics become substantial quasi-flat.

An area represents a magnetic energy which is defined by enclosure of the magnetic flux linkage of the coil at unaligned angle θA, the magnetic flux linkage of the coil at unaligned angle θU, and a current line Im. When a magnetic energy and a one-step angle between the unaligned positions (i.e. angular difference between θU and θA) is defined as W and θ0, the average torque TA can be expressed by W/ θ0. Thus, by increasing the magnetic energy W and decreasing the angle θ0 causes this average torque TA to increase. As for the latter method, decreasing the angle θ0 can be established by increasing the number of the poles such that the stator and the rotor are made to have 12 and 8 poles, respectively or vice verse. However, in general, decreasing the angle θ0 causes the magnetic energy W to decrease proportionally, which results in increasing the average torque TA can not be attained. Thus, it is essential to increase the magnetic energy W itself per one step.

As a means for increasing the magnetic energy W, it is necessary, on the magnetization curve, to realize the following items.

(1) Increasing the desaturated aligned inductance

(2) Increasing the maximum linkage magnetic flux

(3) Decreasing the unaligned inductance

(4) Increasing the linkage magnetic flux at inflection point

These characteristics can be derived from the following formulas.

(1)At-desaturated aligned inductance La

La=μ₀×S₁×N²×A/L_{G}

where

μₒ: magnetic permeability in vacuum

S₁: overlapping area between the rotor and the stator

N: the number of turns

A: the number of poles

L_{G}: air-gap length between the rotor and the stator.

(2) Maximum linkage magnetic flux Pm.

Pm=S₂×Bm×N×A

where

S₂: Minimum cross-sectional area in the magnetic circuit

Bm: Maximum magnetic flux density

N: the number of turns

A: the number of poles.

(3) Unaligned inductance Lu

Lu=k×N²×C

where

k: Leakage inductance constant per slot

N: the number of turns

A: the number of poles.

(4) At-inflection-point linkage magnetic flux Ps

Ps=Bs×L_{G}/(μ₀×N).

where

Bs: Saturated magnetic flux density

Optimizing each parameter is an essential qualification in SR motor design and, for example, increasing N i.e. the number of turns may be proposed. If the number of turns N is increased, as apparent from the aforementioned formulas, the At-desaturated aligned inductance La and the Maximum linkage magnetic flux Pm increase, which contributes to increase the magnetic energy W. However, as can be understood from the formula, the unaligned inductance Lu to be decreased is increased and the at-inflection-point linkage magnetic flux Ps to be increased is decreased. Thus, in particular, the resultant or increased unaligned inductance Lu disturbs the current rising-up when the SR motor is rotated at a high speed (i.e. at the maximum driving frequency), which results in a fatal drawback that the torque to be generated is restricted upon high speed running of the SR motor.

In addition, provided that the space in which the coil is accommodated, the resistive value of the coil, increases in proportion to the square of the number of the turns, which results in making the SR motor to have larger electric power loss (i.e. ‘copper loss ). Thus, increasing the number N of turns, which contributes to increase the torque generated at low speed rotation of the SR motor, results in reversing the high speed performance and efficiency.

On the other hand, as an important essential means for increasing both the at-desaturated aligned inductance La and the Maximum linkage magnetic flux Pm, there is a proposal which increases both the overlapping area S1 between the stator 1 and the rotor 2 and the minimum magnetic circuit cross-section S2. In addition, as a means for reducing the upon-out-of-alignment inductance Lu, there is a method for enlarging the distance between the opposing poles (such as stator poles, rotor poles, or stator and rotor poles) for reducing the magnetic flux leakage k upon out -of-alignment. However, such a method is difficult to employ due to a space restriction in regard to the conventional SR motor as will be detailed later, if an SR motor which is capable of generating sufficient torque upon its high speed rotation is desired, such an SR motor can not be free from being enlarged in size.

Referring to FIGS. 32 and 33, there are illustrated stator and rotor pole angles and a relationship between the stator and rotor pole angles, respectively. FIGS. 32 and 33 are quoted from the reference titled ‘Switched Reluctance Motors and their Control’ (T. J. E. Miller. MAGNA PHYSICS PUBLISHING). Though this reference says that setting each of rotor and stator pole angles is desirable such that each of the pole angles falls into an area inside the triangle ABC illustrated in FIG. 33, in general, the practical range of each of the rotor and stator pole angles varies from 30 to 36 degrees, when totally considering the generated torque, output, efficiency, and ripple torque. That is, in the conventional SR motor, the rate of the overlapping angle between the rotor and the stator relative to a full rotation (360 degrees) becomes 8.33-10%.

It can be concluded that this ratio is the factor which restricts the conventional SR motor performance. This means that even if the poles of the stator 1 and the rotor 2 are increased, so long as such an increase is followed by changing the ratio of the overlapping angle, the problem can not be solved. To the contrary, increasing the number of the poles of each of the stator 1 and the rotor 2 carelessly, the distance between two opposing poles becomes shorter upon out-of-alignment, which increases the leakage magnetic flux and additionally the number of slots accommodating windings, resulting in the cause of increasing the out-of-alignment inductance, thereby indicating that there is a limit in torque increase.

Thus, a need exist to provide an SR water, for perfectly and in a revolutionary manner overcoming the aforementioned problems or drawbacks, which is capable of improving the magnetic pole utilization by increasing an overlapping angle between poles which produce a torque.

### SUMMARY OF THE INVENTION

The present invention has been developed to satisfy the request noted above and a first aspect of the present invention provides a motor which comprises: a stator, a rotor, and a plurality of phase coils which are energized successively for rotating the rotor, characterized in that

(1) one of the stator and the rotor includes a first surface which is opposed to the other of the stator and the rotor, the first surface being formed therein with a plurality of slots which are extended in the axial direction, which are circumferentially arranged along the first surface, and which accommodate the coils when the coils are wound, and a plurality of poles formed between two of the slots which are adjacent to each other,

(2) the other of the stator and the rotor includes a second surface which is opposed to one of the stator and the rotor, the second surface being provided thereon with a plurality of circumferentially arranged magnetic material pieces which are mutually independent of each other,

(3) the magnetic material pieces magnetically couple the two adjacent poles, when the magnetic material pieces are opposed to two adjacent poles,

(4) a torque is produced by a magnetic flux generated in a closed circuit which is constituted by the two adjacent poles and the magnetic material piece placed therebetween, upon coil energization.

A second aspect of the present invention is to provide a motor which comprises: a first member;

a second member opposed to the first member;

one of the first member and the second member being fixed, the other of the first member and the second member being movable,

the first member having a first surface opposed to the second member, the second member having a second surface opposed to the first member, one of the first surface and the second surface being provided therein with at least a slot;

a coil provided in the slot;

a pair of members adjoining the slot constituting a pair of poles and whereby a magnetic flux is generated between the pair of poles upon energization of the coil;

at least a magnetic material piece provided on the other of the first surface and the second surface, the magnetic material piece magnetically coupling, when being approached to the slot, both the poles adjacent the slot in order to constitute a closed magnetic circuit through which a magnetic flux passes which is generated between poles, the magnetic flux, when being changed, producing a displacing force relative to the magnetic material piece, thereby producing a force by which one of the first member and the second member is made movable relative to the other of the first member and the second member.

A third aspect of the present invention is to provide a motor which is a modification of the structure of the second aspect, wherein the first member is of a cylindrical shape with an outer diameter, the second member is of a cylindrical shape with an inner diameter which is larger than the outer diameter of the first member in order to define a gap between the inner diameter of the second member and the outer diameter of the first member, the coils constitute a plurality of phase groups such that energizing the coils is made successively group-by-group.

Fourth and fifth aspects of the present invention provide motors which are modifications of the structure of the first aspect and the third aspect, wherein each of the coils is wound such that at least one of slots is placed between each of the coils, and each of the coils intersects with another coil.

Sixth and seventh aspects of the present invention provide a motors which are modifications of the structure of the first aspect and the second aspect, wherein the poles are constructed such that wide poles and narrow poles are arranged alternately in the circumferential direction, circumferential width of the wide poles is wider than the circumferential width of the narrow poles, winding of each of the coils is made in the axial direction such that the coil is accommodated in the slots at adjacent to the wide pole.

Eighth and ninth aspects of the present invention provide motors which are modifications of the first aspect and the second aspect, wherein the magnetic material piece is formed into a mountain shape which extends away from the opposing pole.

Tenth and eleventh aspects of the present invention modification of structure of the first aspect and the second aspect, wherein the magnetic material piece is formed therein with a groove adjacent to the opposing pole.

Twelfth and thirteenth aspects of the present invention provide motors which are modifications of the structure of the first aspect and the second aspect, wherein the magnetic material piece is made larger than its opposing pole in circumferential width.

A fourteenth aspect of the present invention is to provide a motor which comprises: a first member, a second member, one of the first member and the second member being used as a stator, the other of the first member and the second member being used as a rotor, the rotor being made rotatable relative to the stator, characterized in that

(1) the first member includes a first surface which is opposed to the second member, the first surface being provided with a plurality of poles which are arranged in the circumferential direction along the first surface and which extend in the axial direction, the first surface being formed therein with a plurality of slots in such a manner that each of the slots is placed between the poles which are adjacent to each other, two of the slots between which a plurality of other slots are placed are made to accommodate therein each of circumferentially arranged plural coils upon winding thereof which are to be grouped for constituting plural phases,

(2) the second member includes a second surface which is opposed to the first member, the second surface being provided thereon with a plurality of circumferentially arranged magnetic material pieces which are magnetically independent with respect to each other,

(3) when the magnetic material piece is opposed to the plural poles which are consecutive in the circumferential direction, the consecutive poles are magnetically coupled, the poles and the magnetic material piece constitute a closed magnetic circuit when each of the phases is energized to generate a magnetic flux, thereby producing a rotation torque,

(4) in each of the grouped phases, different coils which are accommodated in the slots which are next to another are to be supplied with currents of same polarity.

A fifteenth aspect of the present invention is to provide a motor which is a modification of the structure of the fourteenth aspect, wherein ends of the coils which are different in phase intersect on the pole such that the coils accommodated in the slots which are next to another have the same in current supply polarity.

An sixteenth aspect of the present invention is to provide motors which are modifications of the structure of the fourteenth aspect and the tenth aspect, wherein each of the phases is constituted by grouping the coils the number of which is even.

In accordance with each of the first aspect and the second aspect of the present invention, one of the magnetic material pieces is made isolated magnetically from another in the circumferential direction of the first member and is opposed to two adjacent poles for being coupled magnetically therewith upon coil energization, whereby the SR motor can produce a torque in continual fashion without between-phase interference.

In accordance with the third aspect of the present invention, energizing the coil is made successively group-by-group.

In accordance with each of the fourth aspect and the fifth aspect of the present invention, it is possible to generates magnetic fluxes such that an angular distance between two adjacent magnetic fluxes can be set at any value as viewed from the center.

In accordance with each of the sixth aspect and the seventh aspect of the present invention, in each phase, no intersections are made between coils, resulting in shortening the length of the coil end, whereby the SR motor becomes available in a specific use wherein the axial length of tie SR motor is restricted.

In accordance with each of the eighth aspect and the ninth aspect of the present invention, it possible to minimize the possible magnetic leakage from one magnetic material piece to the next magnetic material piece with the magnetic passage cross-section attained.

In accordance with each of the tenth aspect and the eleventh aspect of the present invention, the inductance is made smooth relative to the rotation angle, thereby reducing the torque ripple.

In accordance with each of the twelfth aspect and the thirteenth aspect of the present invention, the number around of linkage magnetic flux can be increased.

In accordance with the fourteenth aspect of the present invention, one of the magnetic material pieces is made isolated magnetically from another in the circumferential direction of the first member and is opposed to two adjacent poles for being coupled magnetically therewith upon coil energization, whereby the SR motor can produce a torque in continual fashion without between-phase interference. In addition, in one phase different coils are made the same in coil current supply polarity, whereby upon energization of a phase in the neighboring coils of the resulting phase magnetic fluxes are produced to cancel each other. In other words, in one phase, though even the magnetic flux affect appears in each of the different coils, between these different coils such magnetic flux affect is made much smaller. Thus, when two phases are energized for energization switching from a specific phase to the next phase, the current which flows through the former (the latter) becomes stable continually or free from the magnetic flux affect of the latter (the former), which results in quick rising-up in energizing the latter and in quick falling-down in deenergizing the former, whereby preferable advantages can be provided such that a torque can be produced quickly upon energization of the latter and producing a reverse torque can be restricted due to energizing the former phase.

In accordance with the fifteenth aspect of the present invention, it is possible to comply with a design change of a SR motor by constructing a structure wherein ends of the coils which are different in phase intersect on the pole such that the coils are made the same in current supply polarity.

In accordance with the sixteenth aspect of the present invention, when each of the phases is constituted by grouping the coils, the number of which is even, it becomes possible to make all the coil current supply polarities the same at all positions where different coils are neighbored. Thus, in one phase, even though the magnetic flux affect appears in each of the different coils, between these different coils the magnetic flux affect is made much smaller. Thus, when two phases can be energized for energization switching from a specific phase to the next phase.

### BRIEF DESCRIPTION OF THE DRAWINGS

The above and other objects, features and advantages of the present invention will be more apparent and more readily appreciated from the following detailed description of preferred exemplary embodiments of the present invention, taken in connection with the accompanying drawings, in which;

FIG. 1 illustrates a radial cross-sectional view of an SR motor in accordance with a first embodiment of the present invention in such a manner that basis structure elements : rotor, stator, and phase coils are of being seen;

FIG. 2 is an explanatory view of the SR when the SR motor is in its first operational step;

FIG. 3 is an explanatory view of the SR when the SR motor is in its second operational step;

FIG. 4 is an explanatory view of the SR when the SR motor is in its third operational step;

FIG. 5 illustrates a modified version of the SR motor which is shown in FIG. 2;

FIG. 6 illustrates a radial cross-sectional view of an SR motor in accordance with a second embodiment of the present invention in such a manner that basis structure elements: rotor, stator, and phase coils are seen;

FIGS. 7 illustrates a portion which constitutes the gist of the SR motor which is shown in FIG. 6;

FIGS. 8(a) to 8(d) illustrate how the rotor operates when a magnetic piece is not formed therein with a groove;

FIGS. 9(a) to 9(d) illustrate how the rotor operates when the magnetic piece is formed therein with a groove;

FIG. 10 is a graph showing how an overlapping area between the outer circumferential surface and the stator pole changes with respect to the rotation angle;

FIG. 11 is a graph showing how a magnetic flux linkage changes with respect to the rotation angle;

FIG. 12 is a graph showing how a generated torque changes with respect to the rotation angle;

FIG. 13 illustrates an axial cross-sectional view of an assembled structure of the SR motor as shown in FIG.6;

FIG. 14 illustrates a cross-sectional view taken along line A-A in FIG. 13;

FIG. 15 illustrates a radial cross-sectional view of an SR motor in accordance with a third embodiment of the present invention in such a manner that basis structure elements: rotor, stator, and phase coils are capable of being seen;

FIG. 16 is an explanatory view of the SR which is shown in FIG. 15 when the FIG. 15-illustrating the SR motor is in its first operation step;

FIG. 17 is an explanatory view of the SR which is shown in FIG. 15 when the FIG. 15-illustrating the SR motor is in its second operation step;

FIG. 18 is an explanatory view of the SR which is shown in FIG. 15 when the FIG. 15-illustrating the SR motor is in its third operation step;

FIG. 19 illustrates an axial cross-sectional view of an inner rotor type SR motor to which the present invention is applied;

FIG. 20 illustrates a radial cross-sectional view taken along B-B in FIG. 19;

FIG. 21 illustrates a radial directional cross-sectional view of an SR motor in accordance with a fourth embodiment of the present invention in such a manner that basis structure elements rotor, stator, and phase coils are seen;

FIG. 22 is an explanatory view of the SR of the second embodiment when the SR motor of the fourth embodiment is in its first operation step;

FIG. 23 is an explanatory view of the SR of the second embodiment when the SR motor of the fourth embodiment is in its second operation step;

FIG. 24 is an explanatory view of the. SR of the second embodiment when the SR motor of the fourth embodiment is in its third operation step;

FIG. 25 illustrates a modified version of the SR motor which is shown in FIG. 22;

FIG. 26 illustrates a radial cross-sectional view of an SR motor in accordance with a fifth embodiment of the present invention in such a manner that basis structure elements rotor, stator, and phase coils are seen;

FIG. 27 illustrates a radial cross-sectional view of a conventional SR motor in which basis structure elements: rotor. stator, and phase coils are seen;

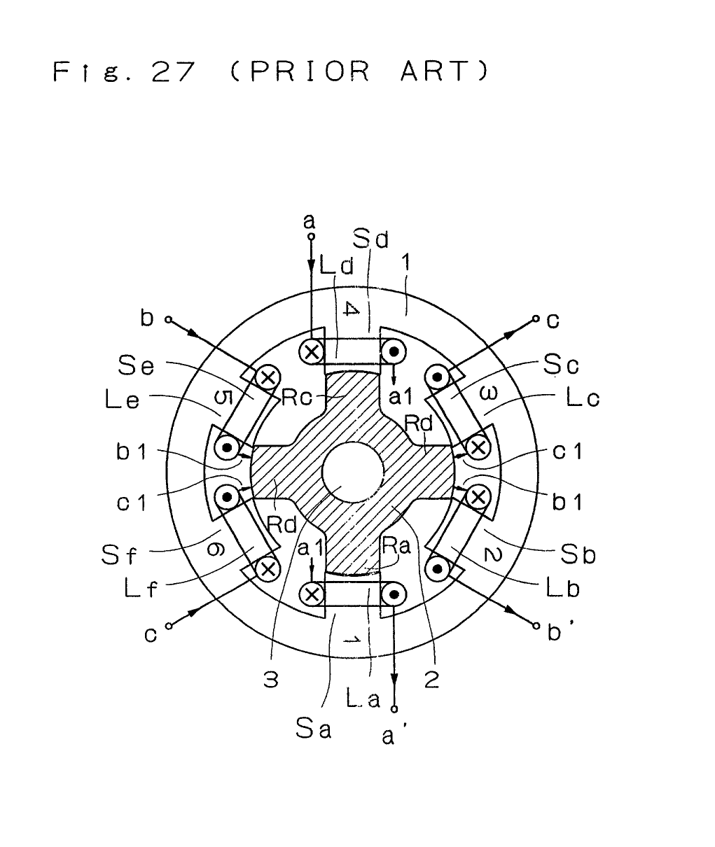

FIG. 28 illustrates the principle of how the conventional SR motor operates, together with its structure and windings shown.

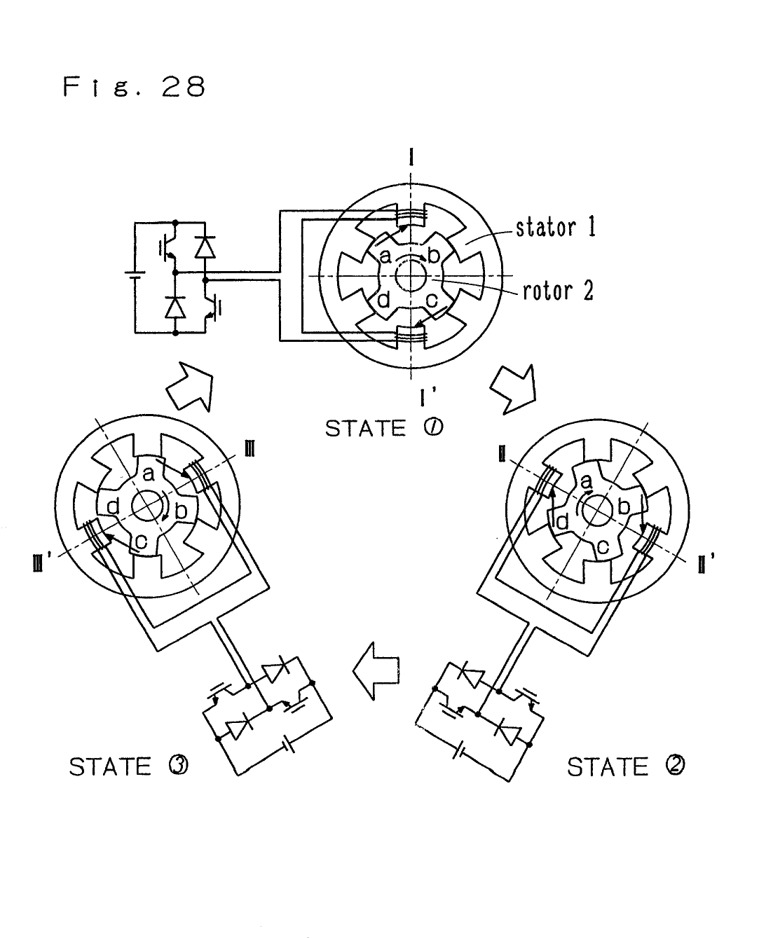

FIG. 29 illustrates a circuit diagram of a driving circuit which drives the conventional SR motor which is illustrated in FIG. 27;

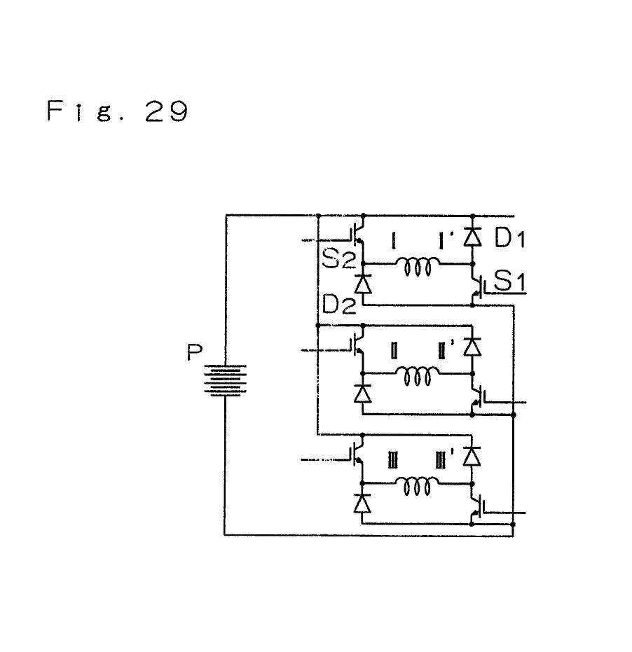

FIG. 30 illustrates, with respect to a specific phase, a coil inductance, a current, and the resultant or generated torque when the current passes through the coil;

FIG. 31 illustrates the magnetization curve of the SR motor;

FIG. 32 illustrates how rotor pole and stator pole angles are formed; and

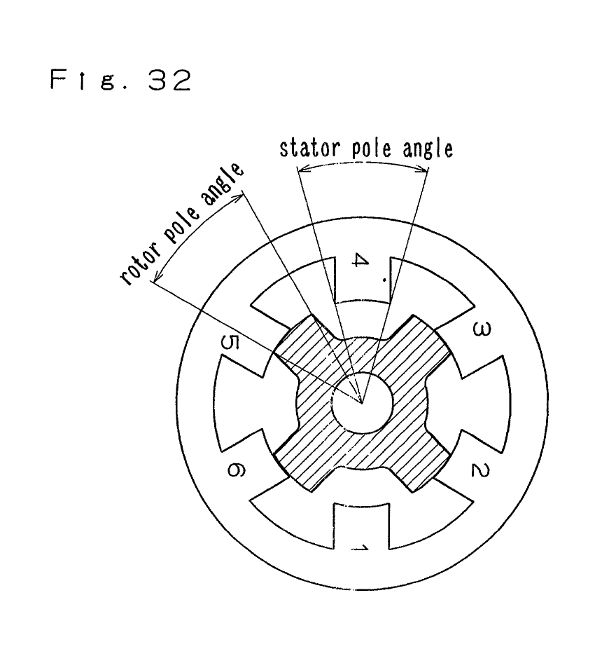

FIG. 33 illustrates a graph which represents the relationship between the stator pole angle and the rotor pole angle.

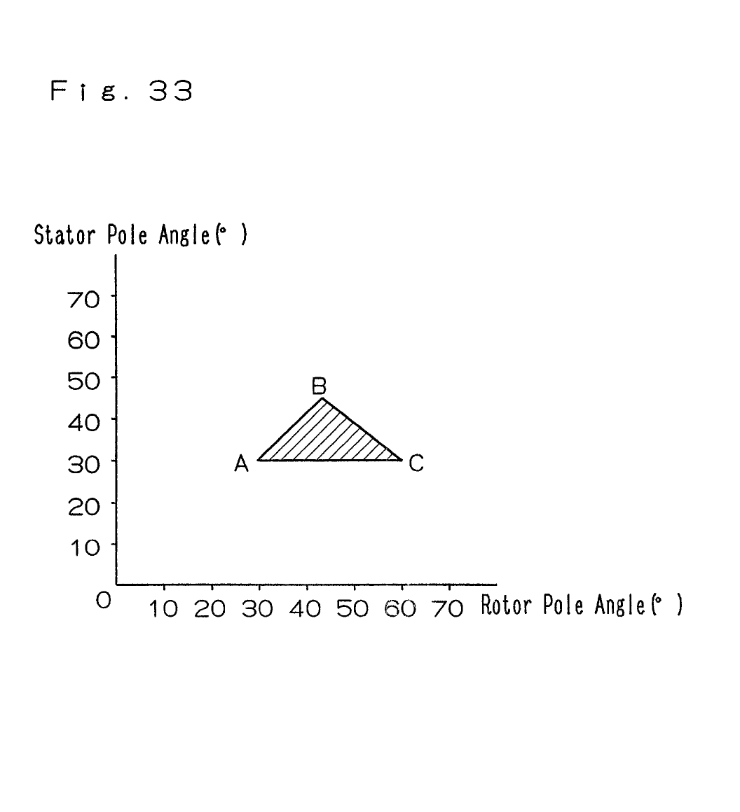

### DETAILED DESCRIPTION OF THE PRESENT INVENTION

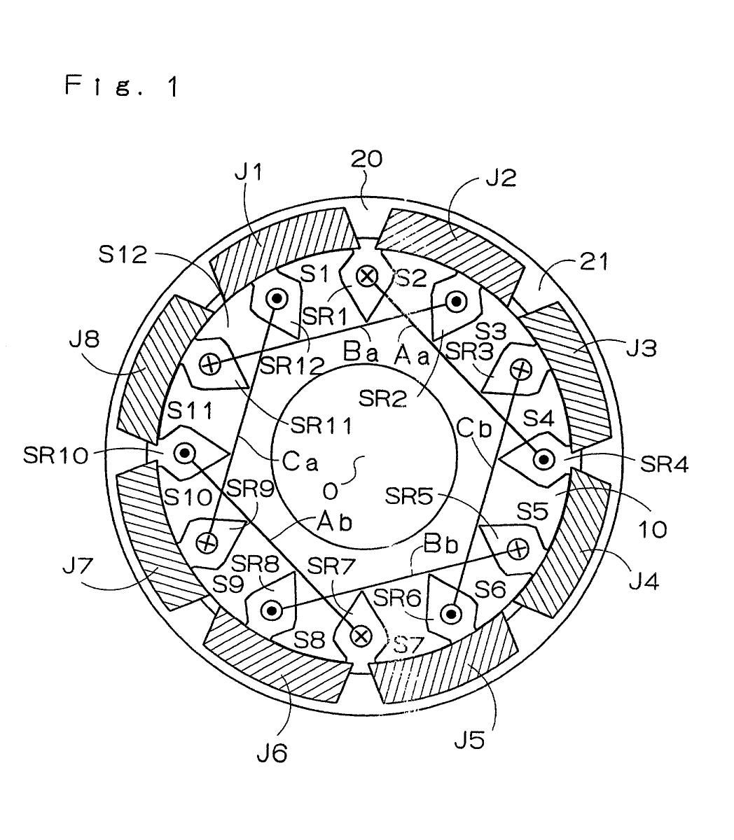

Referring to FIG. 1, there is illustrated a radial direction cross-sectional view of an SR motor (i.e. Switched Reluctance Motor) in accordance with a first embodiment of the present invention.

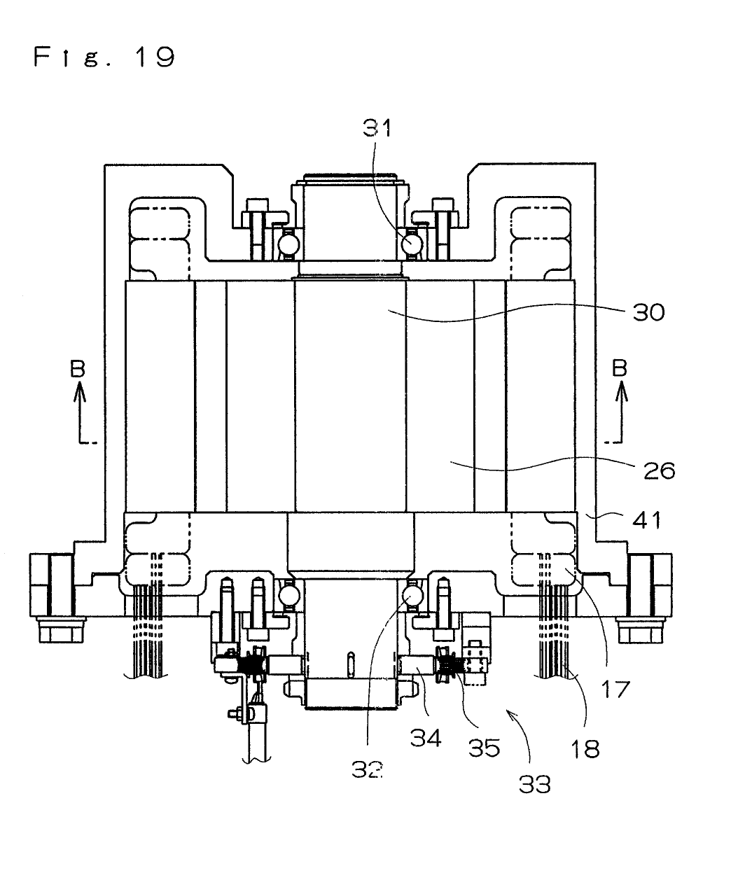

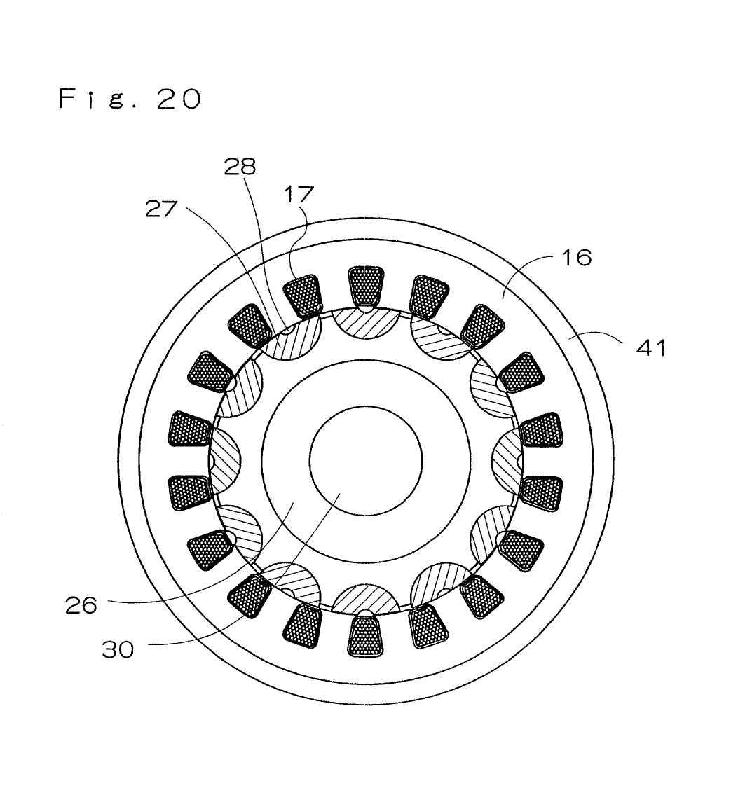

The SR motor, which is shown in FIG. 1 as the first embodiment of the present invention, is formed into outer rotor type in which a rotor 20 rotates on a stator 10. However, the SR motor can be formed into an inner rotor type in which a rotor rotates within a stator as will be detailed later with reference to FIGS. 19 and 20. It is to be noted that one of the stator 10 and the rotor 20 constitutes a first member, while the other of the stator 10 and the rotor 20 constitutes a second member.

The stator 10 is configured into a round-bar shape having a predetermined diameter and is formed of a magnetic subsistence. Along an circumferential direction of the stator 10, twelve (12) equally spaced poles Si through S12 and twelve (12) equally spaced slots SR1 through SR12 are formed in such a manner that the poles and the slots are arranged alternately. It is to be noted that both the poles and slots can be arranged irregularly in the circumferential direction, though such arrangements are not shown. Each of the slots SR1-SR12 is of a wedge-shaped cross-section and extends in the axial direction of the stator 10, while each of the poles S1-S12 is configured such that a distal end of each pole is expanded toward the outer surface of the stator 10. It is to be noted that each of the slots SR1-SR12 may be twisted in the axial direction within the stator 10.

Coils Aa, Ab, Ba, Bb. Ca, and Cb are wound on the stator 10 in such a manner that a specific coil is accommodated in two slots between which two other slots are positioned, as can be seen from FIG. 1. The SR motor is designed to be under three-phase control. A first pair of the coils Aa and Ab, a second pair of the coils Ba and Bb, and a third pair of the coils Ca and Cb constitute a first phase, a second phase, and a third phase, respectively. The paired coils are connected in series or parallel. In FIG. 1, a symbol ‘X indicates a current direction or polarity which extends into the paper, while a symbol ‘●’ indicates a current direction or polarity which extends from the paper. It is to be noted that the illustration in FIG. 1 doe not mean that currents flow in all coils.

The rotor 20 is in form of a cylinder having therein an axially extending bore whose diameter is made larger than the outer diameter of stator 10 so as to define a predetermined gap there between. The rotor 20 is designed to rotate along the outer surface of the stator 10. The rotor 20 is illustrated in FIG. 1 as a rotation member 21 having a ring-shaped cross-section 21. Eight magnetic substance or material pieces J1 through J8 are arranged in equally spaced fashion along an inner surface of the rotation member 21 such that the pieces J1-J8 constitute, as a whole, a ring, and are mechanically secured to the inner surface of the rotation member 21. Of course, arranging the pieces J1-J8 made in irregularly spaced fashion, though it is not shown, is available. The rotation member 21 is formed of nonmagnetic material or weak magnetic material and interrupts a magnetic connection between two adjacent pieces. Thus, each of the pieces J1-J8 is independent from one another magnetically between two adjacent pieces forming a magnetic circuit is impossible or difficult.

Each of the magnetic substance projections J1-J8 is projected slightly from the inner surface of the rotation member 21. A set of the magnetic substance projections J1-J8 is in opposition to a set of the poles Si-S12 such that an adequate gap is defined therebetween in order establish a magnetic coupling between the stator 10 and the rotor 20 which is mechanically stable and is of less magnetic resistance. A width of the inner surface side of each of the pieces J1-J8 is set to be larger than a width of the outer surface side of each of the poles S1-S12 in FIG. 1. However, such a structure is not an essential requirement for the SR motor.

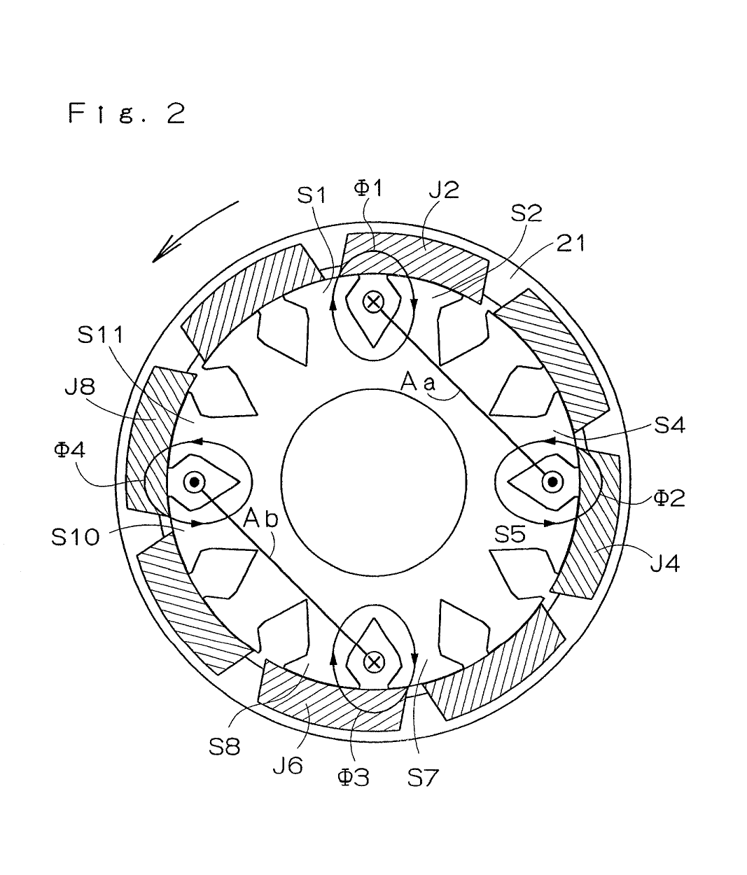

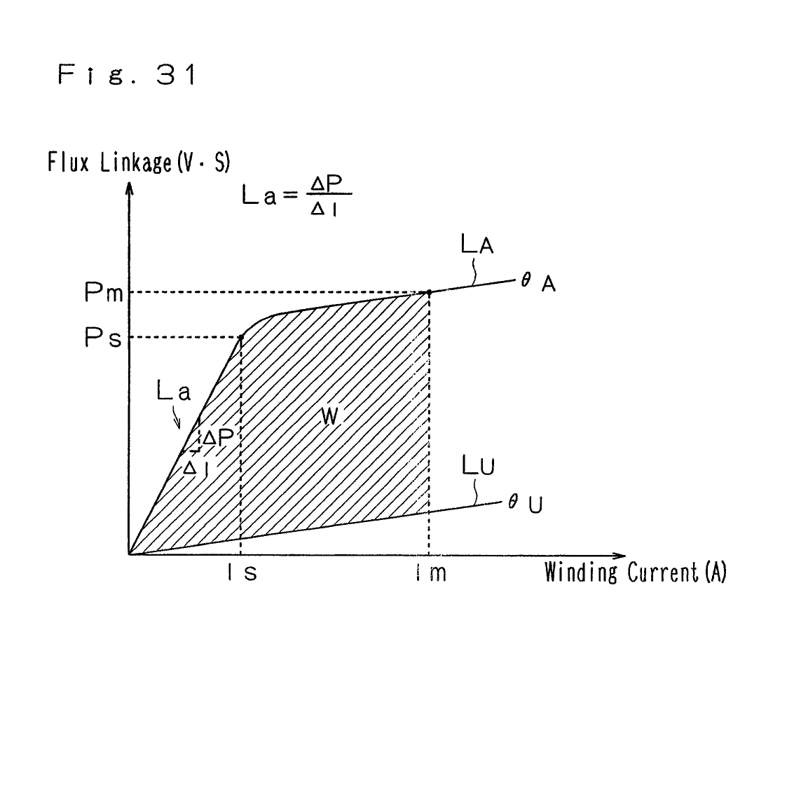

Referring now to FIGS. 2 to 4 inclusive which are prepared for explaining a first operation step, a second operation step, and a third operation step, respectively, of the present SR motor. At first, as shown in FIG. 2, under the illustrated positions of the respective stator 10 and rotor 20, if currents flow through the coils Aa and Ab, respectively, of the first phase, due to the fact that the windings of each of the coils Aa and Ab are made by skipping two slots, between the slot SR1, the slot SR4, the slot SR7, and the slot SR 10, magnetic fluxes Φ1, Φ2, Φ3, and Φ4, respectively, are generated. The slots SR1 and SR4 which accommodates therein the coil Aa make an angle of 90 degrees when viewed from the center of the stator 10, while the slots SR7 and SR10 which accommodate therein the coil Ab make an angle of 90 degrees when viewed from the center of the stator 10. The magnetic flux Φ1 (Φ2/Φ3/Φ4) runs through a closed-loop magnetic circuit which is formed when the magnetic substance piece J2 (J4/J6/J8) and the two adjacent magnetic substance pieces S1 and S2 (S4 and S5/S7 and S8/S10 and S11) enclose the slot SR1 (SR4/SR7/SR10). A rotational torque is generated in a direction of increasing the magnetic flux which runs between the magnetic substance piece J2 and a set of the pair of the poles S1 and S2 (the magnetic substance piece J4 and a set of the pair of the poles S4 and S5/the magnetic substance piece J6 and a set of the pair of the poles S7 and S8/the magnetic substance piece J8 and a set of the pair of the poles S9 and S10) or in a direction of maximizing the magnetic flux coupled to the coil (i.e. the maximum value of the coil inductance). The direction of the torque is indicated with an arrow in each of FIGS. 2 to 4 inclusive. Each of such directions corresponds to a direction of coil inductance which runs from Lu to L_{A}, in FIG. 31.

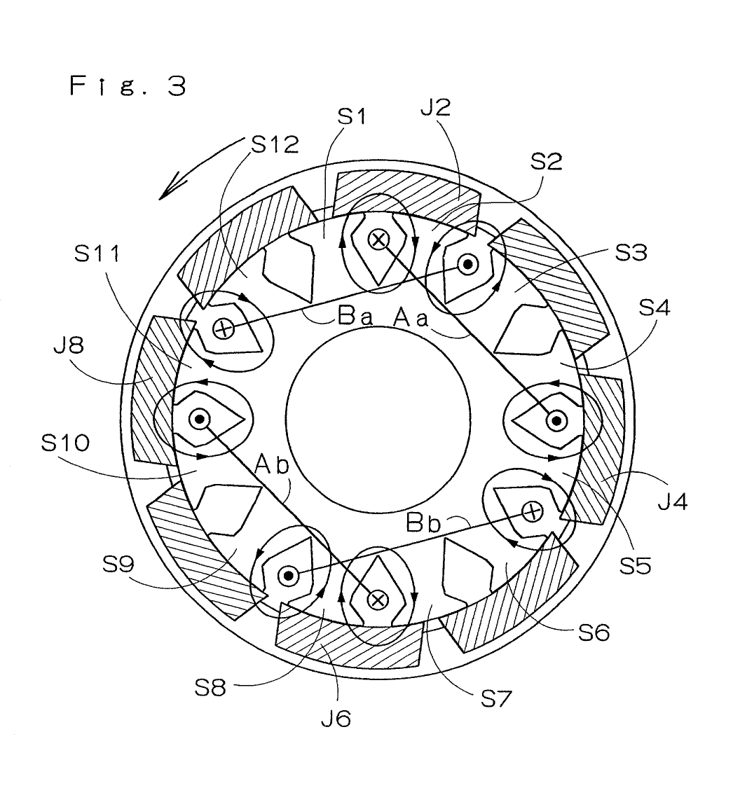

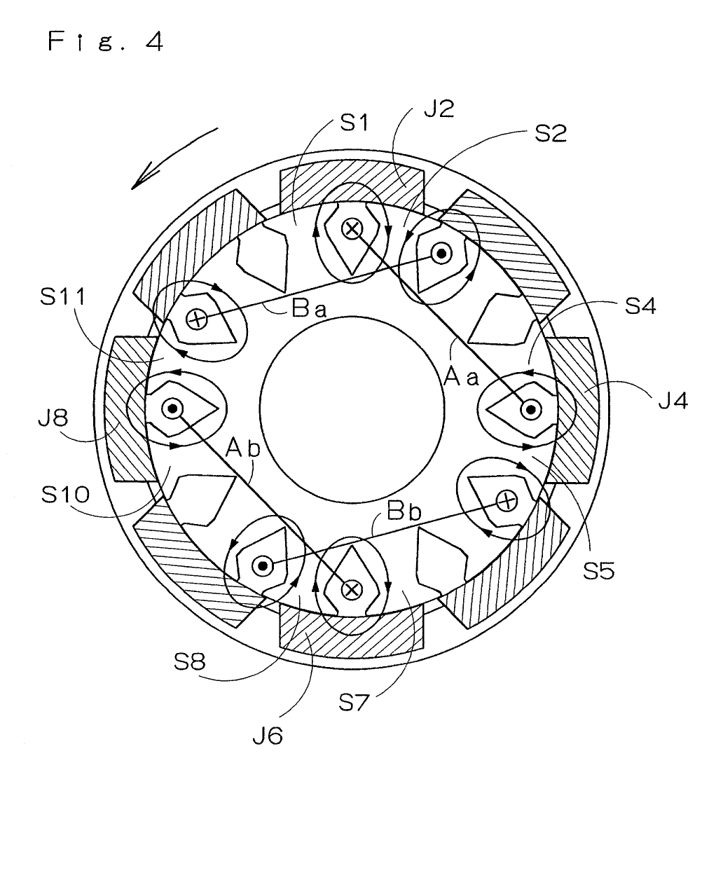

Referring next to FIG. 3 which illustrates a further advanced state of the SR motor when compared to the state thereof illustrated in FIG. 2, a current is going to flow through the coils Ba and Bb of the second phase and at this time point the inductance of each of the coils Ba abd Bb makes the magnetic resistance of the rotor 20 which results from the magnetic material pieces the minimum value relative to the corresponding coils Ba or Bb. That is , in FIG. 3 1, the second phase is at the unaligined position θU and is of an inductance Lu. FIG. 4 illustrates a farther advanced position. Under this state, the flux passes through the pole S1, the magnetic material piece 32, and the pole S2 takes its maximum value, the flux passes through the pole S4, the magnetic material piece J4, and the pole S5 takes its maximum value, the flux passes through the pole S7, the magnetic material piece J6, and the pole S8 takes its maximum value, and the flux passes through the pole S10, the magnetic material piece J8, and the pole S11 takes its maximum value. In FIG. 31, each of the coils Aa and Ab of the first phase takes the aligned position θ_{A} and is of the maximum inductance L_{A}. Under such states, each of the coils Ba and Bb of the second phase are increasing and produce the torque in the arrow direction in succession to the first phase. At this time, the torque produced by the first phase becomes 0. After each of the coils Aa and Ab of the first phase passes the aligned position θ_{A}, interrupting the current supply to the coils Aa and Ab of the first phase is made to prevent the production of torque which is reverse to the rotation direction of the rotor 20. Likewise, advancing the step from the second phase to the third phase makes it possible to produce torque without interruption and back to the first phase repeating the aforementioned performing the first, second, and third phases results in the production of continual torque.

As apparent from the aforementioned description, the flux which is produced around the coil provided or accommodated in each slot flows in such a manner that the flux constitutes a closed circuit which is made up of two adjacent poles and a magnetic material piece which is opposed thereto and which is magnetically isolated from another magnetic material piece in the circumferential direction. The magnetic flux produced by supplying current to the coil wound on the next slot which constitutes the next phase is magnetically isolated from the previous phase, which makes it possible to produce effectively a torque in continual fashion, without being interfering with between-phase interference or inter-phase interference.

In other words, in accordance with the present embodiment, the magnetic flux can flow through a closed circuit which is constituted by one of the magnetic material pieces of the stator 10 and both poles at both sides of the slot of the rotor 20 which oppose the magnetic material piece. Due to the fact that the number of available poles and the magnetic pieces in the circumferential direction of the rotor 20 is increased when compared to the conventional SR motor and due to the fact that the poles S1 to S12 inclusive are shared by different phases, it can be understood that the overlapping area between the stator 10 and the rotor 20 at the aligned position and the cross-section which determines the maximum linkage flux are doubled when compared to the conventional SR motor. Moreover, the magnetic material pieces J1 to J8 inclusive of the rotor 20 are arranged, in magnetically isolated fashion, in the circumferential direction, which restricts the possible magnetic leakage as small as possible at the unaligned position, resulting in the additional advantage that the inductance at the unaligned position can be lessened.

This makes it possible to make the magnetization energy W larger which is indicated in FIG.31. That is to say, it is possible to ensure a sufficient torque without increasing the number of the windings and concurrently to restrict the inductance. It is possible to produce a torque even at high speeds in addition to at low speeds. Thus, a high effectiveness can be derived.

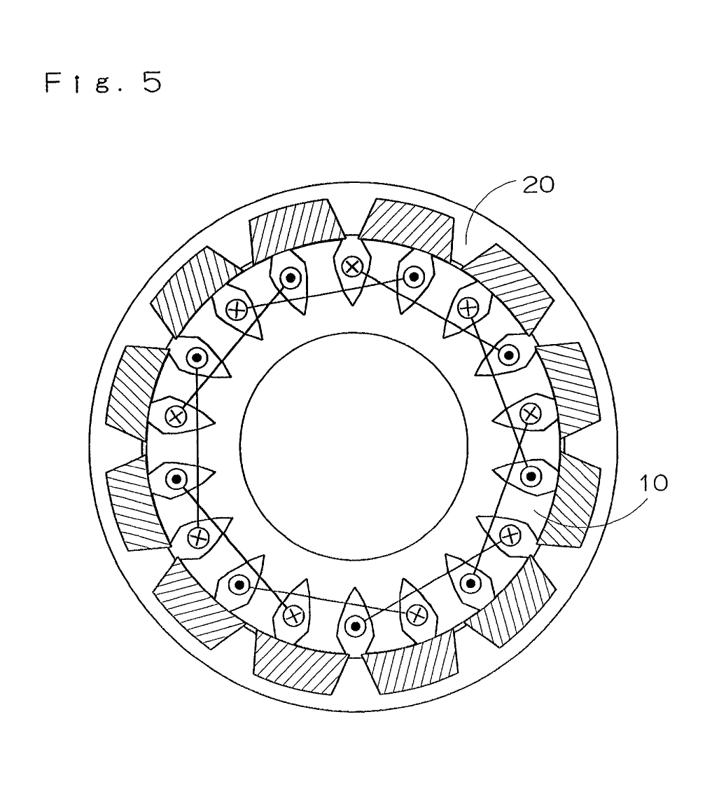

Referring to FIG. 5, there is illustrated another SR motor which is configured by modifying the SR motor such that the number of the poles of the stator 10 and the number of the poles of the rotor 20 are eighteen (18) and twelve (12), respectively. Such a structure brings an advantage in that the coil length can be shortened when compared to the structure depicted in FIG. 1.

In each of the structures shown in respective FIG. 1 and FIG. 5, the ratio of the number of the coils of the stator 10 to the number of the magnetic material pieces is 3:2 (12 8 in FIG. 1/18:12 in FIG. 5). This ration is, though it is determined in consideration of torque to be produced, output, effectiveness, torque ripple, and so on, is not restrictive.

In addition, the structure illustrated in each of FIG. 1 and FIG. 5 is in the form of a cantilever type wherein only one side of the rotor or outer rotor is supported by the shaft, which makes it impossible to extend considerably the length of the shaft. However, such a structure can provide advantages in that the SR motor , as a whole, can be miniaturized and it is easy to derive the torque.

Moreover, contrary to the structure shown in each of FIG. 1 and FIG. 5 wherein the poles, slots and coils and the magnetic material pieces are provided to the stator 10 and the rotor 20. respectively, it is possible to provide the magnetic material pieces and the poles, slots and coils to the stator 10 and the rotor 20, respectively, such that a brush is used for supplying current to the coils of the rotor 20.

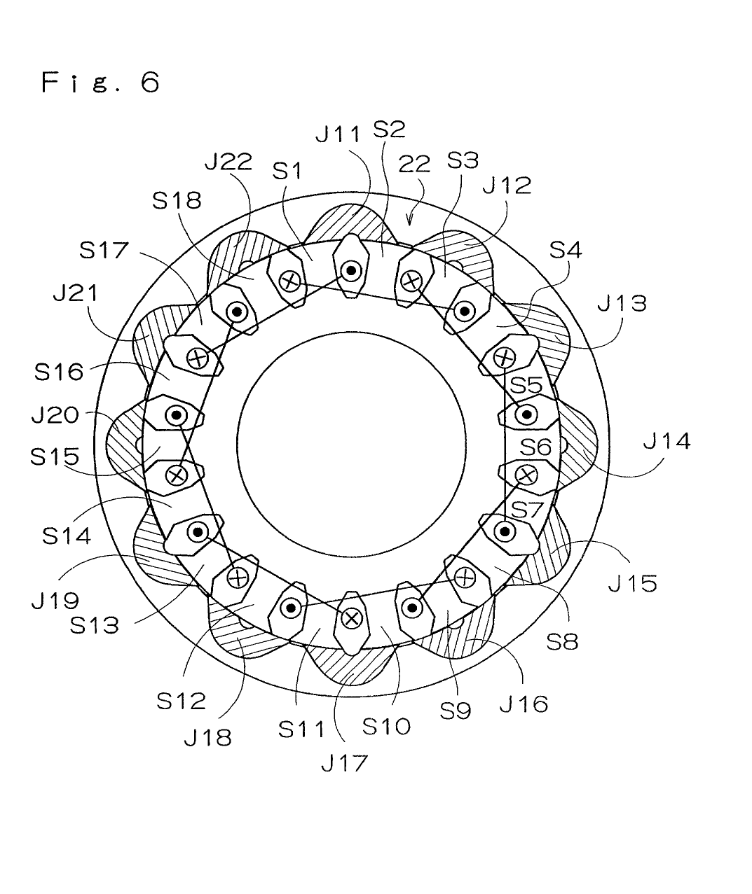

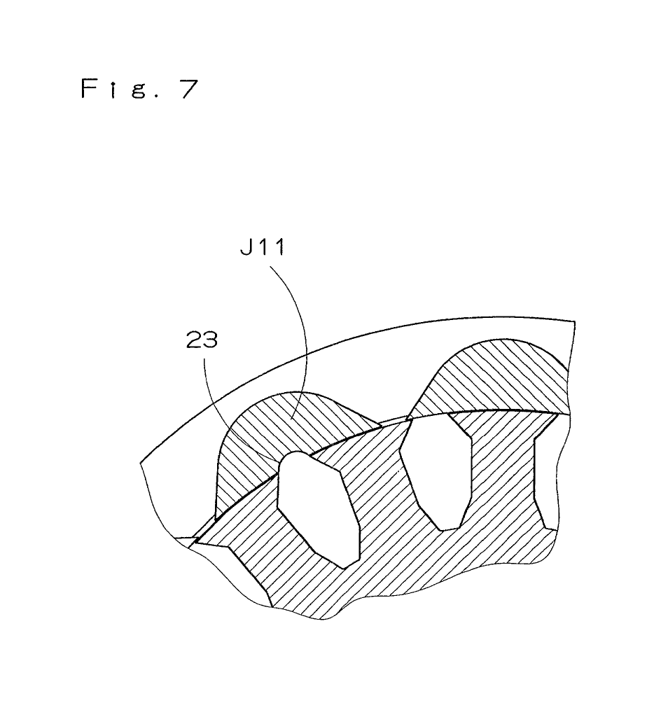

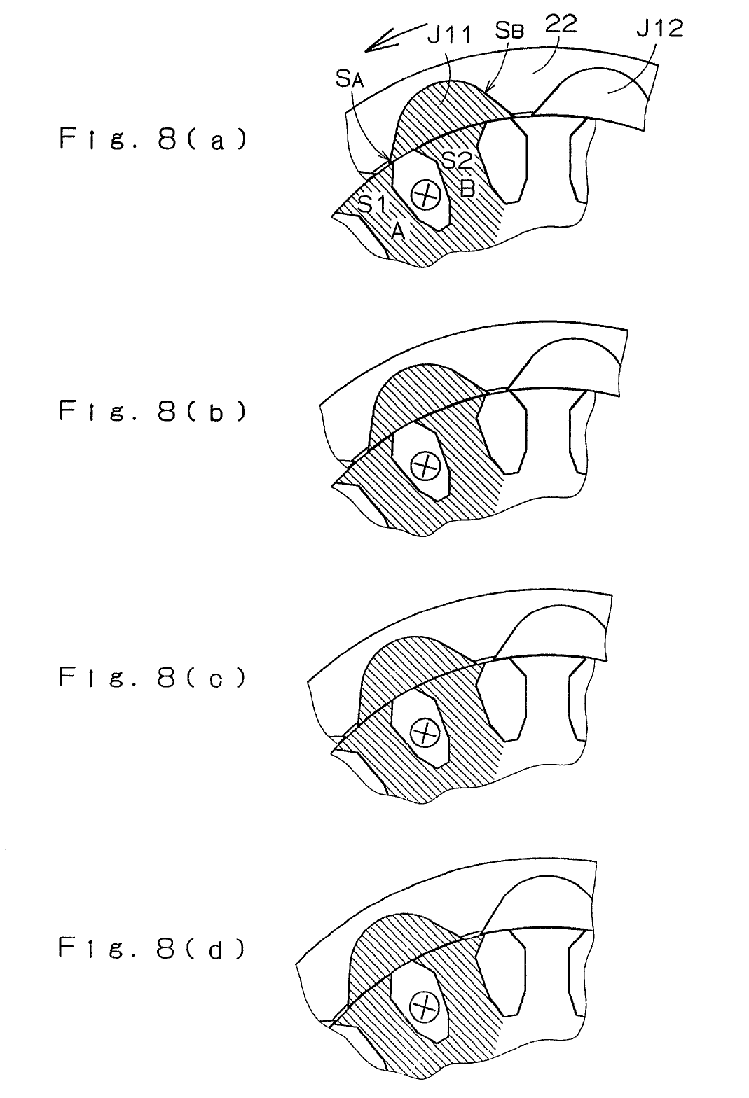

Referring now to FIG. 6, there is illustrated a radial cross-sectional view of an SR motor in accordance with a second embodiment of the present invention. The gist of the second embodiment of the present invention is illustrated in FIG. 7 in an enlarged scale. In the present embodiment illustrated in FIG. 6, for minimizing the magnetic leakage from each of the magnetic material pieces of the rotor 22 illustrated in FIG. 5, each of magnetic material pieces J1 through J22 of the rotor 20 is formed to have a substantially shallow semi-circular shape in axial cross-section i.e. the cross-sectional area of each magnetic piece becomes narrowed progressively from the inner surface side toward the outer surface side of the rotor 20. In addition, as best shown in FIG. 7, in an inner surface of each of the magnetic material pieces J11 through J22, there is provided a groove 23, which extends in the axial direction, so as to oppose to the outer surface of the stator 10 on which the poles S1 through S18 are formed. Forming such grooves 23 makes the change of the inductance relative to the rotation angle smoother, thereby reducing the torque ripple. The reason will be explained hereinafter with reference to FIGS. 8(a) through 8(d), FIGS. 9(a) through 9(d), FIG. 10, FIG. 11, and FIG. 12.

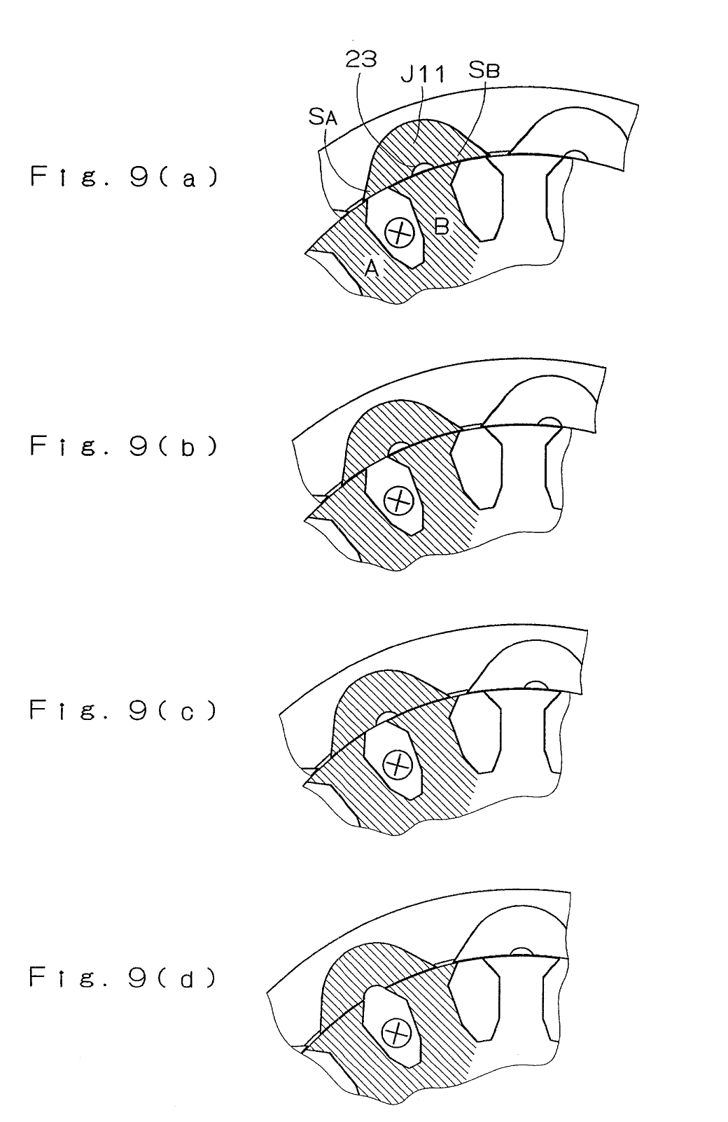

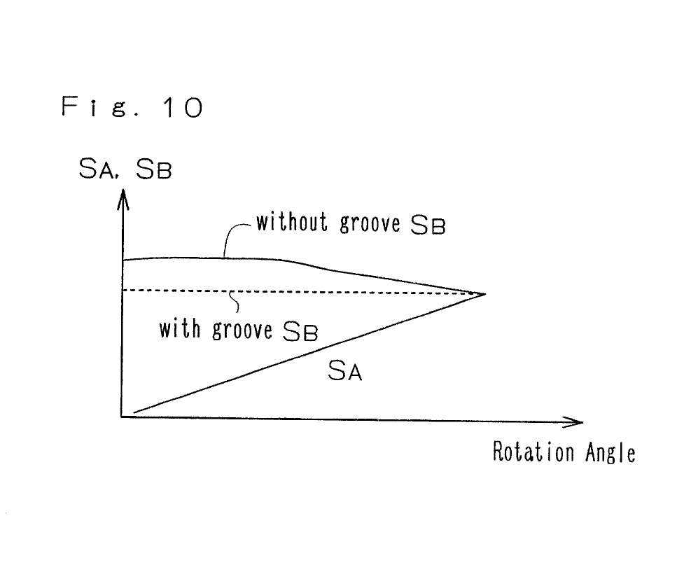

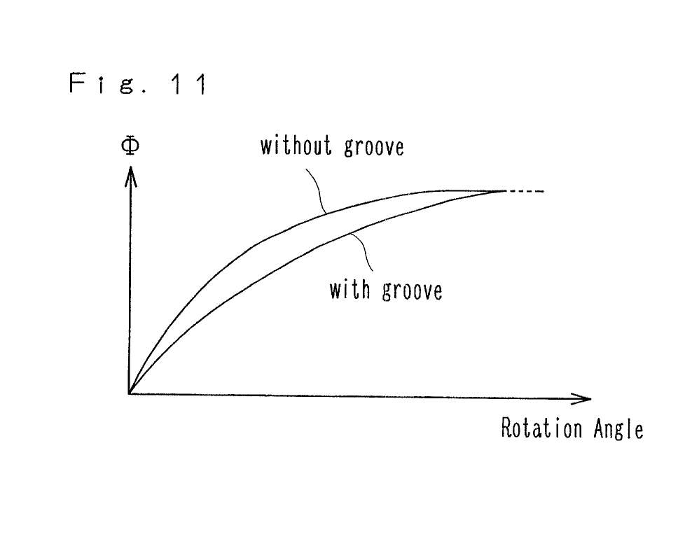

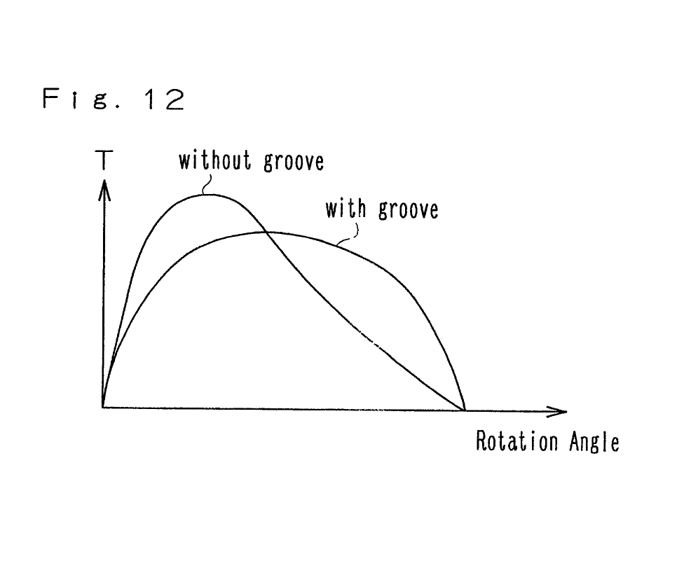

FIGS. 8(a) to 8(d) inclusive illustrate how the rotor operates when each of the magnetic material pieces is not formed therein with a groove, FIGS. 9(a) to 9(d) inclusive illustrate how the rotor operates when each of the magnetic material pieces is formed therein with a groove, FIG. 10 illustrates a graph which represents how an overlapping area between the outer circumferential surface and the stator pole changes with respect to the rotation angle, FIG. 11 illustrates a graph which represents how a magnetic flux linkage changes with respect to the rotation angle. and FIG. 12 illustrates a graph which represents how a produced torque changes with respect to the rotation angle.

In FIG. 8 and FIG. 9, the overlapping area between the magnetic material piece J11 and the pole S1 is defined as SA. while the overlapping area between the magnetic material piece J11 and the pole S2 is defined as SB. In a case where the magnetic material piece J11 is not provided therein with the groove 23, the rotor 22 begins to rotate from the illustrated state in FIG. 8(a) in the direction indicated by the arrow in FIG. 8(a) and advances to take the illustrated states in FIGS. 8(b), 8(c); and 8(d) in such an order. Thus, though the overlapping area SA increases in proportion to the rotation angle as can be seen from the graph in FIG. 10,. the overlapping area SA represented in FIG. 8(a) is identical with the overlapping area represented in FIG. 8(b), the overlapping area SA decreases progressively as the state proceeds to FIG. 8(c) and FIG. 8(d).

On the other hand, in a case where the groove 23 is formed in each of the magnetic material pieces, as the rotor 22 rotates as shown in FIGS. 9(a), 9(b), 9(c), and 9(d) in such an order, though the overlapping area SA increases similar to the illustrations in the respective FIGS. 8(a), 8(b), 8(c), and 8(d), the overlapping area SB fails to change or remains unchanged.

In detail, in FIG. 8(a) the outer surface or outer periphery of the pole S2 is in full overlap with the inner surface of the magnetic material piece J11, while in FIG. 9(a) the forming of the groove 23 results in reducing the overlapping area correspondingly. Thus, during the advancement from the state in FIG. 9(a) to the state in FIG. 9(d), the overlapping area SA increases progressively but the overlapping area SB can remain unchanged or be of a fixed value.

When the magnetic material piece J11 is not provided or formed therein with the groove 23, though changing the overlapping area SB causes the linkage flux to increase in smooth fashion as shown in FIG. 11, after the midway, the linkage flux tends to be saturated. On the other hand, when the magnetic material piece J11 is provided or formed therein with the groove 23, though as a whole the linkage flux is lowered correspondingly to the groove 23, the linkage flux is increased without being saturated or in a smooth manner and the linkage flux when the groove 23 is formed becomes, in the last result, identical with the linkage flux when the groove 23 is not formed.

Thus, when the magnetic material piece J11 is not provided or formed therein with the groove 23, the produced torque is large at an initial stage of rotation but thereafter as the rotation angle increases the produced torque drops suddenly or abruptly. To the contrary, though the maximum value of the produced torque when the magnetic material piece J11 is provided or formed therein with the groove 23 is smaller than the maximum value of the produced torque when the magnetic material piece J11 is not provided therein with the groove 23, the former becomes substantially stable or flat. Thus, the change of rotor relative to the rotation angle is made smoother, thereby reducing the torque ripple.

It is to be noted in the illustrations in FIG. 6, FIG. 7, FIGS. 8(a), 8(b), 8(c), and 8(d), and FIGS. 9(a), 9(b), 9(c), and 9(d), respectively, making the inner surface of each of the magnetic material pieces larger than the outer surface of each of the poles in width is not restrictive and therefore it is possible to make the inner surface of each of the magnetic material pieces equal to the outer surface of each of the poles in width.

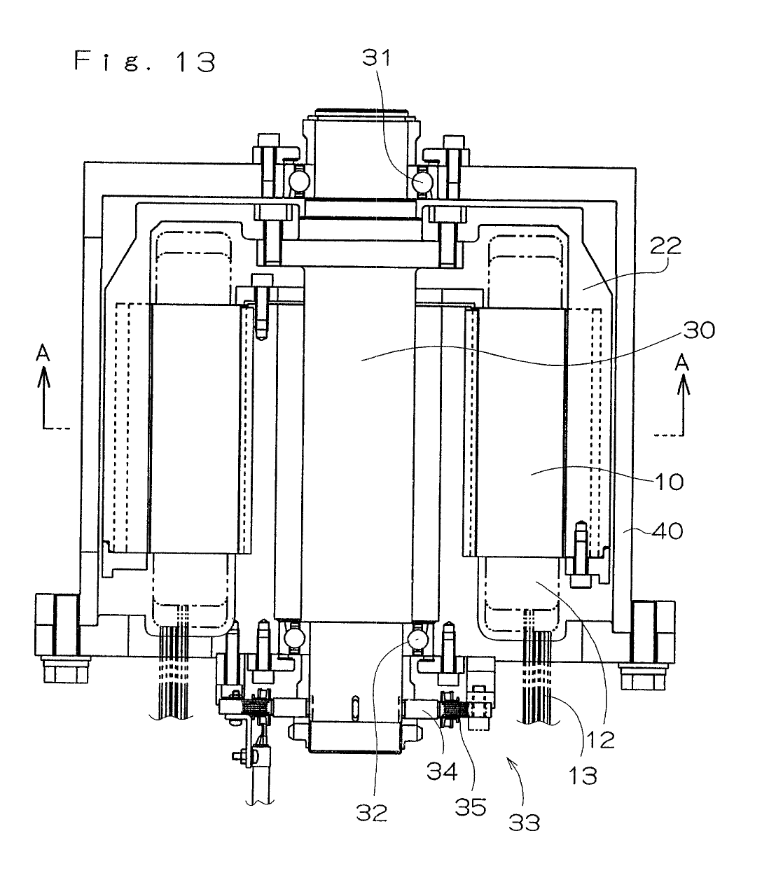

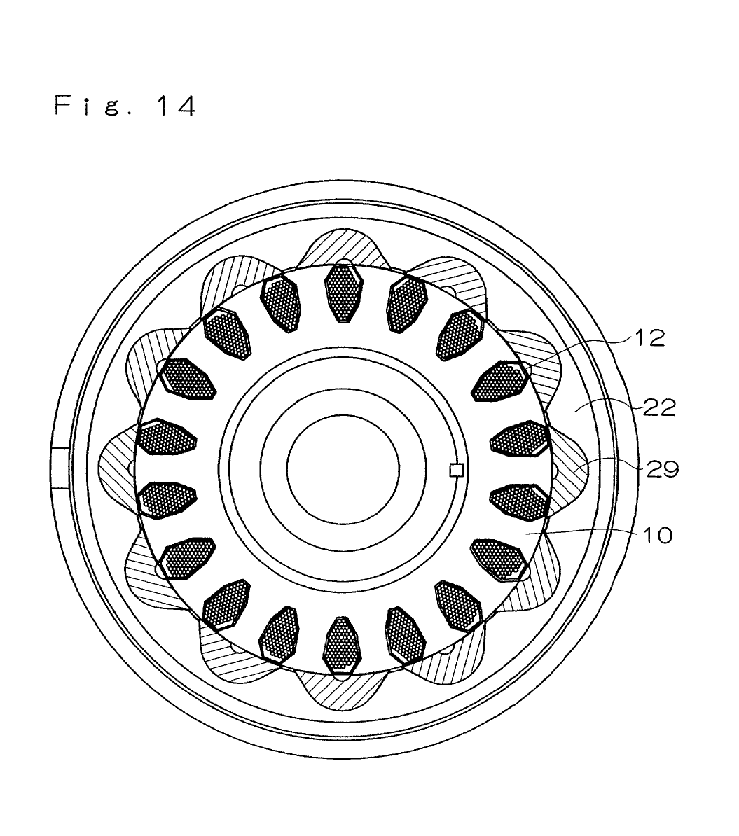

Referring to FIG. 13, there is illustrated an axial cross-sectional view of an assembled structure of the SR motor whose radial cross-section taken along line A-A is illustrated in FIG. 14.

In FIGS. 13 and 14. the rotor 22 is fixedly mounted on a shaft 30. The rotor 22 is fixed with a plurality of twelve equally spaced magnetic material pieces (in the drawing the number thereof is twelve (12)). The stator 10 is wound with a plurality of coils 10 and lead lines 13 of each of the coils 10 are connected to a driving circuit (not shown) by way of terminals (not shown). A housing 40 retains the stator 10 and a pair of axially spaced bearings 31 and 32. The shaft 30 is connected with a rotor 34 of a rotor angle sensor 33. A stator 35 of the rotor angle sensor 33 is connected to the housing 40. The rotor angle sensor 33 is used for determining an angular position the rotor 22. An output signal which represents the current angular position of the rotor 22 is fed to a controller (not shown). The controller drives or energizes the coils in phase order depending on the incoming signal.

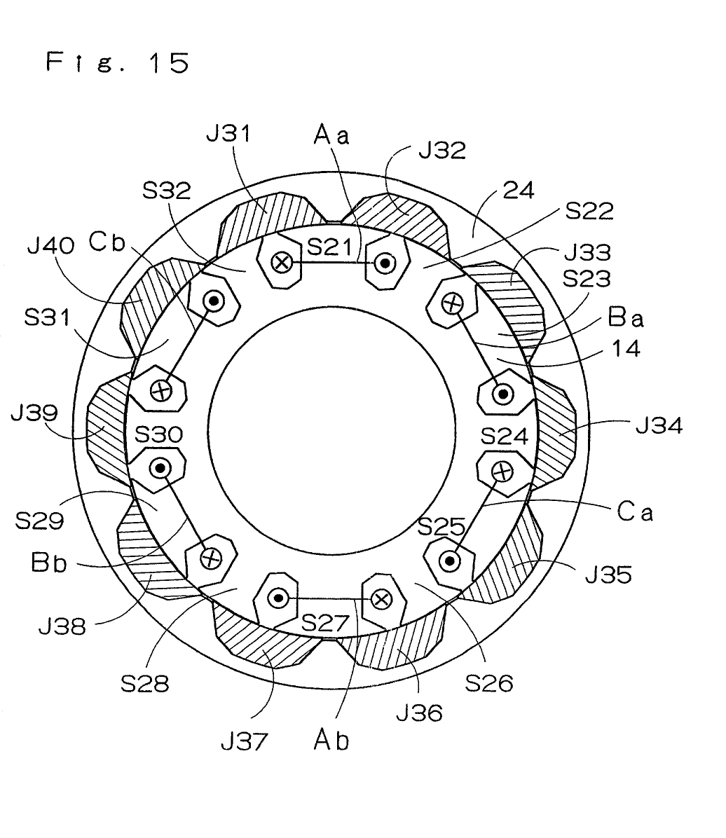

Referring to FIG. 15, there is illustrated a radial cross-section of an SR motor in accordance with a third embodiment of the present invention. When compared to the structure illustrated in each of FIGS. 1, 5, and 6 wherein each of the coils is wound on two slots between which two slots are positioned in order to overlap the terminals of two adjacent coils, in the structure illustrated in FIG. 15, each of coils Aa, Ab, Ac, Ba, Bb,Bc, Ca, Cb, and Cc is wound on two adjacent slots of the stator 14. Poles S21, 523, S25, S27, S29, and S31 are made wide, while poles S22, S24, S26, S28, S30, and S32 are made narrow. The coils Aa, Ab, Ba, Bb, Ba, Ca, and Cb, are wound on the wide poles S21, S27, S23, S29, S25, and S31, respectively. A pair of the coils Aa and Ab, a pair of the coils Ba and Bb, and a pair of the coils Ca and Cb constitute the first phase, the second phase, and third phase. On the other hand, the rotor 24 is provided with ten (10) magnetic material pieces J31 through J40.

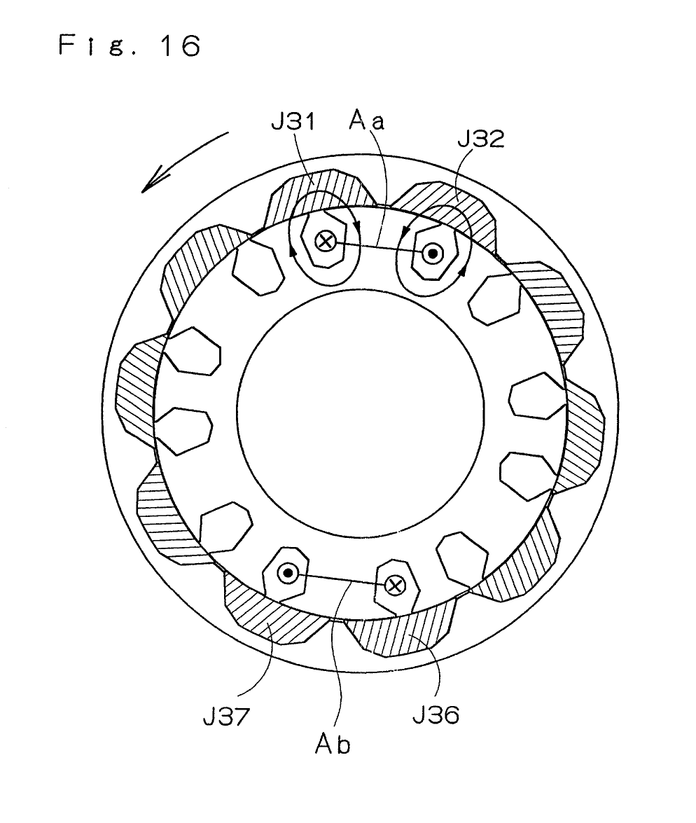

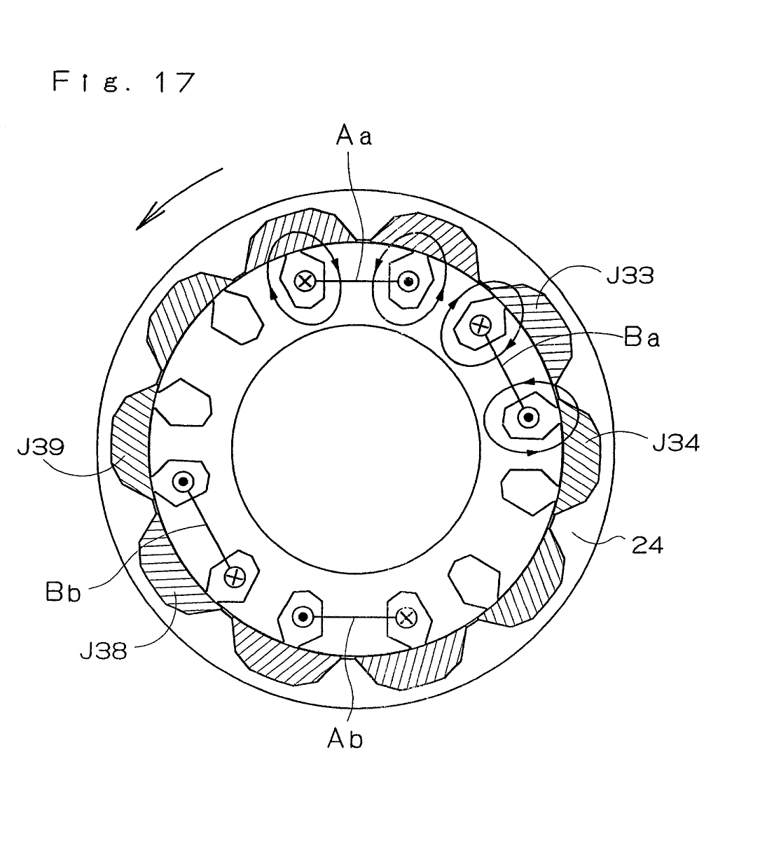

Referring to FIGS. 16 to 18 inclusive, there are illustrated operation steps of the SR motor in accordance with the present embodiment. In FIG. 16, energizing the coils Aa and Ab produces a torque in a direction along which is increased a linkage of the magnetic flux of each of the magnetic material pieces J31, J32, J36. and J37 with the corresponding coils Aa or Ab or in the counter-clockwise direction in FIG. 16. When advanced to the state in FIG. 17, energizing the second phase coils or the coils Ba and Bb produces a torque in a direction along which is increased a linkage of the magnetic flux of each of the magnetic material pieces J33, J34. J38, and J39 with the corresponding coils Ba or Bb. The resultant torque is added to the torque which is produced by energizing the coils Aa and Ab.

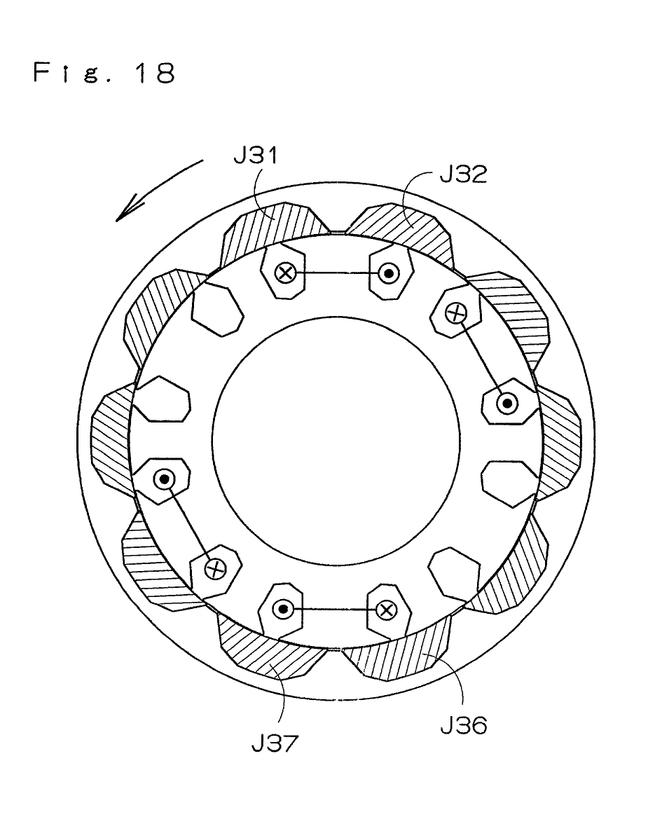

When the state in FIG. 18 is attained after advancement from the state in FIG. 17, a linkage of the magnetic flux of each of the magnetic material pieces J31, J32, J36, and J37 with the corresponding coil Aa or Ab becomes maximum, which fails to produce the torque, thereby deenergizing the coils Aa and Ab which results in that only the torque produced by energizing the coils Ba and Bb remains. Thereafter, similar energization is made to each of the set of the coils Ba and Bb and the set of the coils Ca and Cc for producing the torque in continual mode. At this point, the important item is that similar to the first embodiment shown in FIG. 1 the magnetic material pieces J31 through J40 of the rotor 24 are made magnetically isolated or independent, inter-phase interference fails to appear. Thus, similar to the first embodiment illustrated in FIG. 1, sharing the poles of the stator 14 becomes possible. However, the poles which are capable of being shared are not all poles but only the narrow poles S22, S24, S26, S28, S30, and S32.

In the present embodiment, the wide and narrow poles are arranged alternately for restricting the production of a reverse torque due to the fact that if all poles are made wide a reverse torque will be produced at one of two adjacent poles.

In the present embodiment, the coil is accommodated in two adjacent slots in a concentrated fashion, which results in an advantage that the axial length can be shortened when compared to the first embodiment illustrated in FIG. 1.

In the embodiment illustrated in each of FIG. 1 and FIG. 5, when the stator 10 is brought into alignment with the rotor 20, the overlapping portion (i.e. overlapping angular range) which is defined by the opposing stator 10 and rotor 20 becomes about doubled when compared to the conventional device, which results in that the produced torque can be also doubled, while in the embodiment shown in FIG. 15 the overlapping portion is about 1.3-1.4 times than of a conventional device, which results in that the produced torque becomes about 1.3-1.4 times higher.

Referring to FIG. 19, there is illustrated an axial cross-sectional view of an inner rotor type SR motor whose radial cross-section, taken along line B-B in FIG. 19, is illustrated in FIG. 20.

The inner rotor type SR motor is a structure which is made by reversing the stator and the rotor with each other in the outer rotor type SR motor which is shown in FIGS. 13 and 14. In detail, a rotor 26 is connected to a shaft 30. The rotor 26 is provided with twelve (12) magnetic material pieces 27 in such a manner that the magnetic material pieces 27 extend outwardly in the radial direction from an outer surface of the shaft 30. At a side of the shaft 30, each of the magnetic material pieces is formed into a mountain shape, while an outer surface of each magnetic material piece is formed therein with a groove 28 which extends in parallel to the axis of the shaft 30.

The stator 16 is connected to a housing 41. At an inner surface of the stator 16, there are provided or formed eighteen (18) slots. The slots are wound with coils 17. The coil winding method is available from any one of methods which are employed in the embodiments which are illustrated in FIG. 1, FIG. 5, and FIG. 15, respectively. Lead lines 18 of each of the coils 17 are coupled to a controller (not shown) by way of respective terminals (not shown).

A housing 41 retains the stator 16 and a pair of axially spaced bearings 31 and 32. The shaft 30 is connected with a rotor 34 of a rotor angle sensor 33. A stator 35 of the rotor angle sensor 33 is connected to the housing 41. The rotor angle sensor 33 is used for determining an angular position the rotor 26.

In the inner rotor type SR motor which is illustrated in FIGS. 19 and 20, forming the groove 28 in each of the magnetic material pieces 27 provides advantages which are similar to the advantages which are derived from the embodiment illustrated in FIG. 6. In addition, the SR motor is in the form of inner rotor type, which makes it possible to shorten the axial length of the rotor 26. The resultant SR motor becomes suitable for high speed operation.

Of course, in this inner rotor type SR motor, it is possible to place the magnetic material pieces at the side of the stator 16, to establish the coil windings at the side of the rotor, and to use a brush for the current supply to each of the coils.

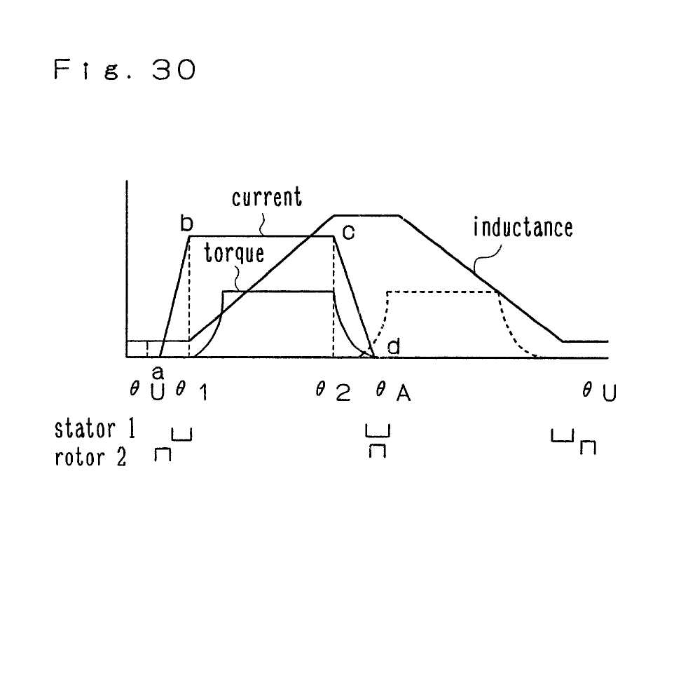

Though each of the disclosed SR motors is in the form of shaft rotation type, it can be used as a linear motor by cutting through the stator and the rotor at a specific point on circular line as is known. In addition, like induction motors, supplying currents through the coils in pump-priming manner makes it possible to provide a power generation function to the SR motor. For this purpose, no current is supplied during a transfer of the rotor from the unaligned position to the aligned position, while during the transfer of the rotor from the aligned position to the unaligned position a current is supplied which changes from ‘a to ‘b in FIG. 30. Thus, a current is produced in the coil which changes from ‘b to ‘d by way of ‘c’ until the rotor reaches the unaligned position.

In accordance with the present invention which is supported by the illustrations in FIGS. 1 to 20 inclusive, one of the magnetic material pieces is made isolated magnetically from another in the circumferential direction of the first member and is opposed to two adjacent poles for being coupled magnetically therewith upon coil energization, so that the SR motor can produce a torque in continual fashion without between-phase interference.

In addition, the overlapping area between poles at the alignment position and the cross-section on which the maximum linkage magnetic flux depends can be double when compared to the conventional SR motor. The magnetic material pieces are magnetically isolated from one another, which results in the minimum magnetic leakage at the unaligned position and which makes it possible to make the magnetized energy as large as possible due to lessened inductance at the unaligned position.

In other words, it is possible to attain the torque as large as possible without increasing the number of the coil windings and concurrently the inductance is restricted as small as possible at the unaligned position, which makes it possible to attain the torque whether the speed is high or low resulting in attaining much higher efficiency.

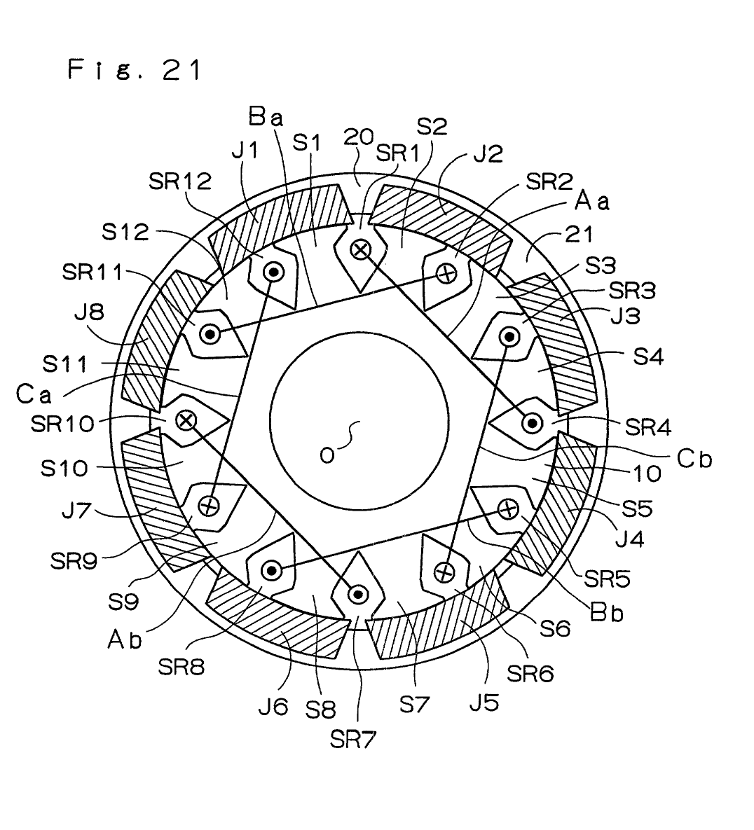

Referring to FIGS. 21 to 24 inclusive, there is illustrated an SR motor in accordance with a fourth embodiment of the present invention. In brief, the SR motor according to the present embodiment differs from the SR motor according to the first embodiment in current supply polarity. Thus, without explaining the present SR motor in construction and operation, it can be understood easily that the present SR motor can provide advantages similar to those derived from the SR motor in accordance with the first embodiment.

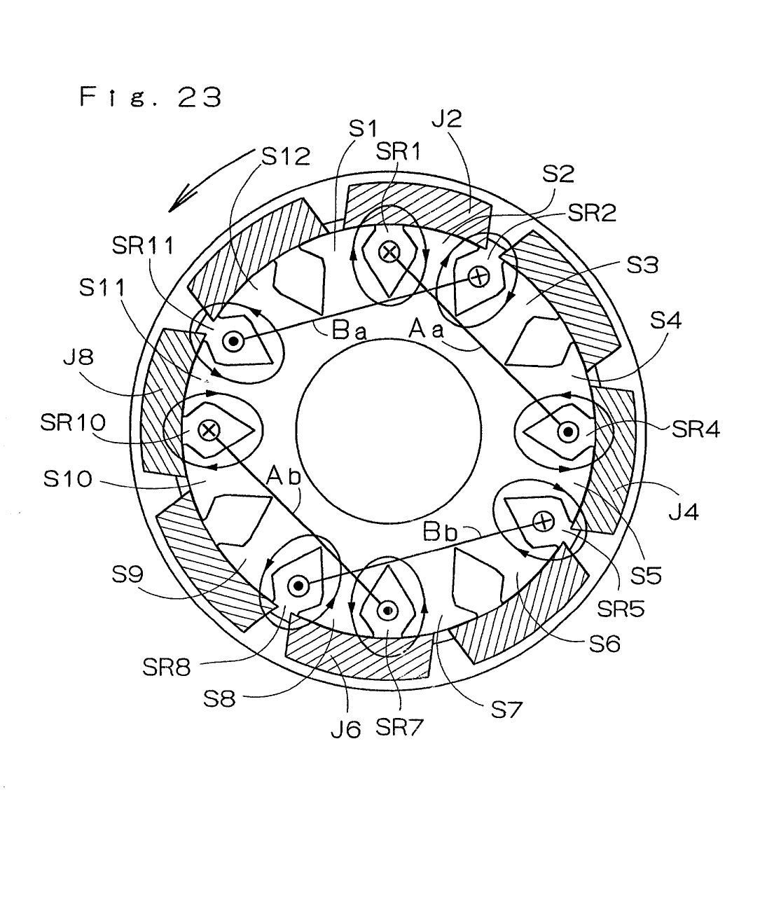

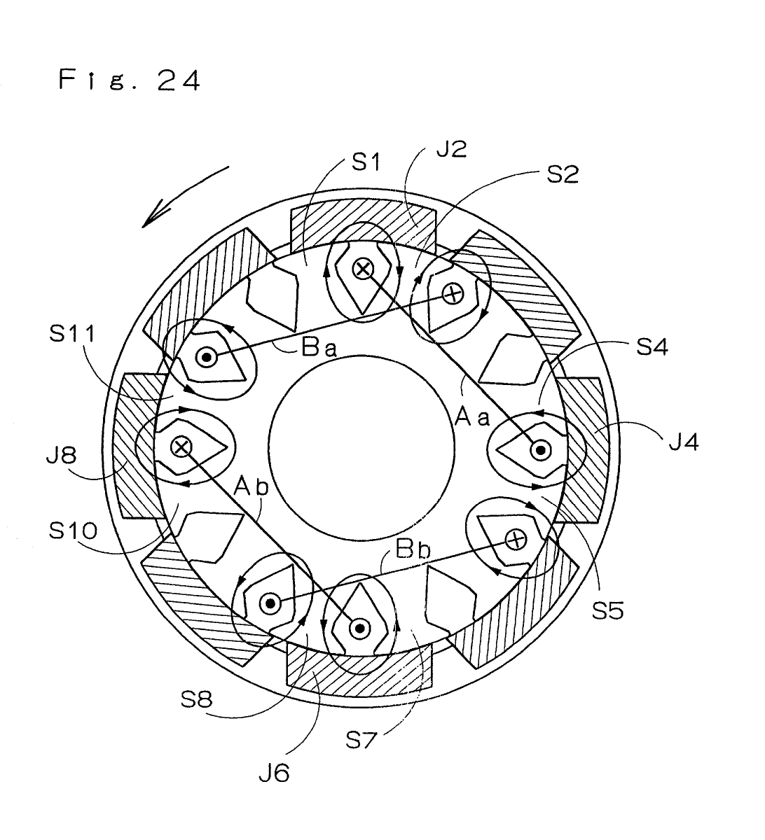

In addition, as illustrated in FIGS. 23 and 24, the current supply polarization of each coil is set in such manner that at a timing of energizing the first phase and the second phase, for example, when the set of coils Aa and Ab of. the first phase and the set of coils Ba and Bb of the second phase are energized concurrently the affect of magnetic flux leakage from one coil on the other coil (i.e. the current flown through one coil causes the other coil to generate a voltage) and the affect of magnetic flux leakage from the other coil on one coil are mutually canceled. That is to say, between two adjacent slots, affects by magnetic flux leakage are found and first of all, when the coil Aa of the first phase is focused, the affect of magnetic flux leakage on the slot SR1 is due to the magnetic flux leakage from the second phase or the slot SR2 in which the coil Bb is accommodated, while the affect of magnetic flux leakage at the slot SR4 in which the coil Aa of the first phase is accommodated is due to the magnetic flux leakage from the second phase or slot SR5 in which the coil Bb is accommodated. These magnetic flux leakages are in opposite directions in the coil Aa and the induced electromotive forces are mutually canceled. Likewise, when the coil Ab or another coil of the first phase is focused, the magnetic flux leakages from the slots SR8 and the SR11 are in opposite directions in the coil Ab, resulting in that the induced electromotive forces are mutually canceled. In addition, even when each of the coils Ba and Bb is focused, the affect of the magnetic flux leakages from the first phase are canceled. That is to say, the coils Aa and Ab are grouped into the first phase such that the coils Aa and Ab are connected in series or in parallel, while and the coils Ba and Bb are grouped into the second phase such that the coils Ba and Bb are connected in series or in parallel. Thus, the affect of the magnetic flux leakages on the second phase from the first phase are canceled and vise versa. Thus, during so-called overlapping duration wherein the first phase and the second phase are energized concurrently inter-phase counter electromotive forces can be made as small as possible, whereby current rise-up and falling-down speeds in each phase depends on only its self inductance. Thus, the current rising-up and falling-down speeds in each phase can be free from the speed-down due to the affect from another phase, which makes it possible to supply the current suitably at a desired timing, resulting in the prevention of lowering rising-up speed of current which reduces the produced torque and/or the prevention of lowering falling-down speed of current which produces the counter torque, thereby restricting the reduction of the produced torque totally as small as possible. Such advantages can appear in a relation between the first phase and the third phase which is constructed by grouping the coils Ca and Cb and a relation between the third phase and the second phase.

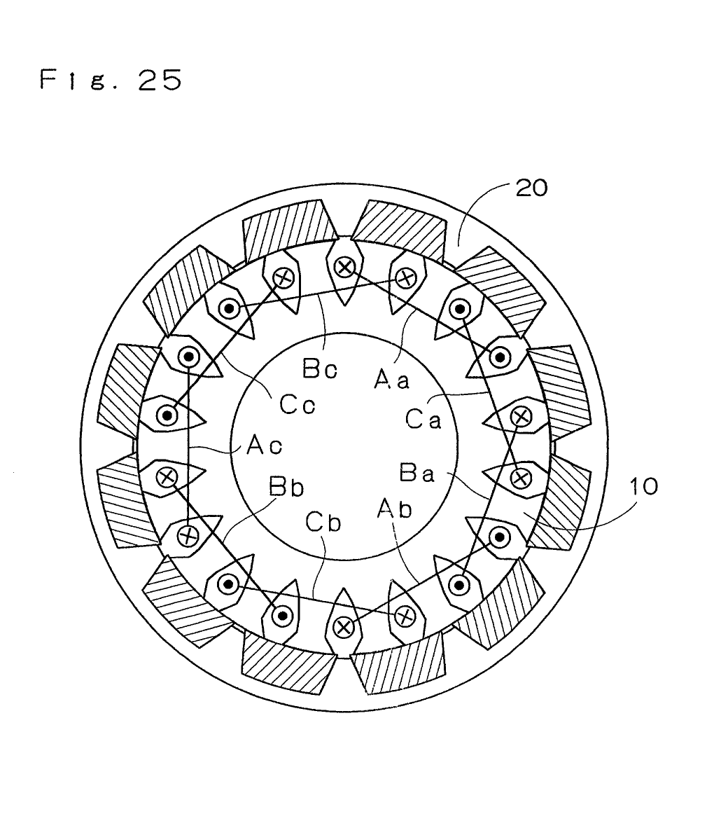

Referring to FIG. 25, there is illustrated an SR motor in accordance with the fifth embodiment of the present invention. The present SR motor is configured to have twenty-four (24) magnetic poles and sixteen (16) magnetic material pieces. When compared to the SR motor illustrated in FIG. 21, the present SR motor can be of advantage in that the coil length can be shortened and can be made more precise in rotation control.

In the present SR motor, a set of coils Aa, Ab, and Ac which are arranged equally in the circumferential direction so as to divide the circumference into three equal parts, a set of coils Ba, Bb, and Bc which are arranged equally in the circumferential direction so as to divide the circumference into three equal parts, and a set of coils Ca, Cb, and Cc which are arranged equally in the circumferential direction so as to divide the circumference into three equal parts, are grouped in the first phase, the second phase, and the third phase, respectively. Though magnetic poles, slots, and magnetic material pieces are not detailed, the magnetic material pieces or the illustrated members with hatching in FIG. 25 differ, in shape, from the magnetic material pieces J1 though J8. This difference is due to design choice and therefore the former pieces are identical with the latter pieces essentially. No further explanation is made with respect to the magnetic material pieces illustrated in FIG. 25.

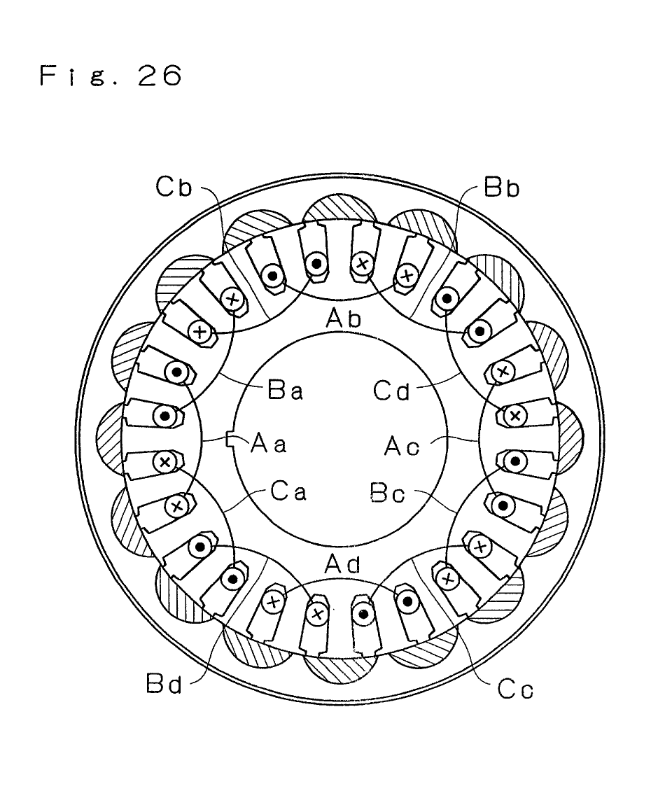

In the embodiments of the SR motor illustrated in FIGS. 21 and 25, respectively, the first phase, the second phase. and the third phase are contracted by grouping an even number of coils. However, an even number of coils are not always grouped into the first phase, the second phase, and the third phase in view of dimensions, torque, output, effectiveness and so on of the SR motor to be constructed. Such a case is shown herein below. Referring to FIG. 26, there is illustrated an SR motor in accordance with a sixth embodiment of the present invention. The present SR motor is of twenty-four (24) stator magnetic poles and sixteen (16) rotor side magnetic material pieces and has an advantage that it is possible to shorten the length coil when compared to the SR motor illustrated in FIG. 21.

As shown in FIG. 25, in the SR motor in accordance with the fifth embodiment of the present invention, a set of coils Aa, Ab, and Ac which are arranged equally in the circumferential direction so as to divide the circumference into three equal parts, a set of coils Ba, Bb, and Bc which are arranged equally in the circumferential direction so as to divide the circumference into three equal parts, and a set of coils Ca, Cb, and Cc which are arranged equally in the circumferential direction so as to divide the circumference into three equal parts, are grouped in the first phase, the second phase, and the third phase, respectively. In each of the phases, for example, in the first phase, three coil pairs can be prepared: a pair of the coils Aa and Ab, a pair of the coils Ab and Ac, and a pair of coils Ac and Aa. With respect to the pair of the coils Aa and Ab, in the neighboring concerned slots, the current supply polarity of the coil Aa is indicated with ‘●’, while the current supply polarity of the coil Ab is indicated with ‘●’. With respect to the pair of the coils Ab and Ac, in the neighboring concerned slots, the current supply polarity of the coil Ab is indicated with ‘x’, while the current supply polarity of the coil Ac is indicated with ‘x’. With respect to the pair of the coils Ac and Aa, in the neighboring concerned slots, the current supply polarity of the coil Ac is indicated with ‘●’, while the current supply polarity of the coil Ab is indicated with ‘x’. As a whole, in the first phase, in two coil pairs, the neighboring current supply polarities are same in direction, while in one coil pair the neighboring current supply polarities are different in direction. Between the slots which are different in current supply polarity, upon energization of the first phase, the resultant magnetic flux increases, thereby increasing the affect of magnetic flux leakage. However, in the present embodiment, in one of the three phases, at only one of the portions at which one of the coils is next to another, the affection of the magnetic flux leakage appears, while at each of the two other portions no affection due to magnetic flux leakage is found. Thus, though when compared to the SR motor in accordance with the fourth embodiment the produce torque is made lowered slightly in the SR motor in accordance with the present embodiment, the affection due to magnetic flux leakage can be made much lowered when compared to the conventional SR motor and therefore the present SR motor is available in practical use.

An alternative structure is available in such a manner that the set of the poles and slots and the magnetic material pieces can be provided to the rotor and the stator, respectively, instead of the illustrated structure in each of FIG. 25 and FIG. 26 and supplying the current to each of the coils is made by brush.

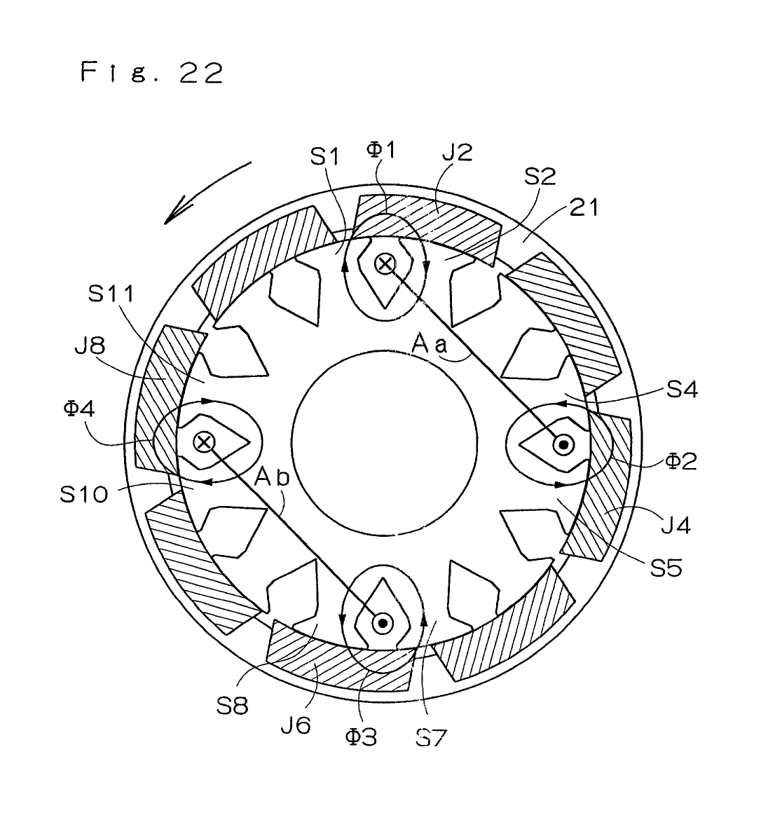

In the embodiment illustrated in each of FIG. 21, FIG. 22, and FIG. 26, the coil is wound on each of the poles extending outwardly in the radial direction, which results in that the current supply polarities in the axial direction of the coils are made same which are accommodated in the circumferentially neighboring slots. However, in light of the fact that the winding direction of the coil depends on the structure of the pole, it is conceivable that in some SR motors the current supply polarities in the radial direction of the coils may be made same which are accommodated in the circumferentially neighboring slots.

It is to be noted the foregoing embodiments are exemplary and are not restrictive, which allows modification of any one of the number of the poles, the number of the slots, and the number of the magnetic material pieces on the basis of factors such as produced torque, output, efficiency, and torque variation, without departing from the gist of the present invention.

In accordance with the present invention which is supported by the embodiments which are illustrated in FIGS. 21 to 26 inclusive, one of the magnetic material pieces is made isolated magnetically from another in the circumferential direction of the first member and is opposed to two adjacent poles for being coupled magnetically therewith upon coil energization, so in that the SR motor can produce a torque in continual fashion without between-phase interference. In addition, phase different coils are made the same in coil current supply polarity, so that upon energization of a phase in the neighboring coils of the resulting phase magnetic fluxes are produced to cancel each other. In other words, in one phase, though even the magnetic flux affect appears in each of the different coils, between these different coils the such magnetic flux affect made much smaller. Thus, when two phases are energized for energization switching from a specific phase to the next phase, the current which flows through the former (the latter) becomes stable continually or free from the magnetic flux affect from the latter (the former), which results in quick rising-up in energizing the latter and in quick falling-down in deenergizing the former, whereby preferable advantages can be provided such that a torque can be produced quickly upon energization of the latter and producing a reverse torque can be restricted due to energizing the former phase.

The invention has thus been shown and description with reference to specific embodiments, however, it should be understood that the invention is in no way limited to the details of the illustrates structures but changes and modifications may be made without departing from the scope of the appended claims.

What is claimed is:

1. A motor comprising: a stator, a rotor, and a plurality of phase coils which are energized successively for rotating the rotor, characterized in that
(1) one of the stator and the rotor includes a first surface which is opposed to the other of the stator and the rotor, the first surface being formed therein with a plurality of slots which are extended in the axial direction, which are circumferentially arranged along the first surface, and which accommodate the coils when the coils are wound, and a plurality of poles formed between two of the slots which are adjacent to each other,
(2) the other of the stator and the rotor includes a second surface which opposes to one of the stator and the rotor, the second surface being provided thereon with a plurality of circumferentially arranged magnetic material pieces which are mutually independent of each other, p1 (3) the magnetic material pieces magnetically couples two adjacent poles, when the magnetic material pieces are opposed to two adjacent poles,
(4) a torque is produced by a magnetic flux generated in a closed circuit which is constituted by the two adjacent poles and the magnetic material piece placed therebetween, upon coil energization.

2. A motor comprising:
a first member;
a second member opposed to the first member;
one of the first member and the second member being made fixed, the other of the first member and the second member being made movable,
the first member having a first surface opposed to the second member, the second member having a second surface opposed to the first member, one of the first surface and the second surface being provided therein with at least a slot;
a coil provided in the slot;
a pair of members adjoin the slot constituting a pair of poles and in which a magnetic flux is generated between the pair of poles upon energization of the coil;
at least a magnetic material piece provided on the other of the first surface and the second surface, the magnetic material piece magnetically coupling, when being approached to the slot, both the poles adjacent the slot in order to constitute a closed magnetic circuit through which a magnetic flux passes which is generated between poles, the magnetic flux, when being changed, producing a displacing force relative to the magnetic material piece, thereby producing a force by which one of the first member and the second member is made movable relative to the other of the first member and the second member.

3. A motor as set forth in claim 2, wherein the first member is of a cylindrical shape with an outer diameter, the second member is of a hollow cylindrical shape with an inner diameter which is larger than the outer diameter of the first member in order to define a gap between the inner diameter of the secondmember and the outer diameter of the first member, the coils constitute a plurality of phase groups such that energizing the coils is made successively group-by-group.

4. A motor as set forth in claim 1, wherein each of the coils is wound such that at least one of slots is placed between each of the coils, and each of the coils intersects with another coil.

5. A motor as set forth in claim 3, wherein each of the coils is wound such that at least one of slots is placed between each of the coils, and each of the coils intersects with another coil.

6. A motor as set forth in claim 1, wherein the poles are constructed such that wide poles and narrow poles are arranged alternately in the circumferential direction, circumferential width of the wide poles is wider than the circumferential width of the narrow poles, winding each of the coils is made in the axial direction such that the coil is accommodated in the slots adjacent to the wide pole.

7. A motor as set forth in claim 2, wherein the poles are constructed such that wide poles and, narrow poles are arranged alternately in the circumferential direction, circumferential width of the wide poles is wider than the circumferential width of the narrow poles, winding each of the coils is made in the axial direction such that the coil is accommodated in the slots adjacent to the wide pole.

8. A motor as set forth in claim 1, wherein the magnetic material piece is formed into a mountain shape which extends away from the opposing pole.

9. A motor as set forth in claim 2, wherein the magnetic material piece is formed into a mountain shape which extends away front the opposing pole.

10. A motor as set forth in claim 1, wherein the magnetic material piece is formed therein with a groove adjacent to the opposing pole.

11. A motor as set forth in claim 2, wherein the magnetic material piece is formed therein with a groove adjacent to the opposing pole.

12. A motor as set forth in claim 1, wherein the magnetic material piece is made larger than its opposing pole in circumferential width.

13. A motor as set forth in claim 2, wherein the magnetic material piece is made larger than its opposing pole in circumferential width.

14. A motor comprising: a first member, a second member, one of the first member and the second member being used as a stator, the other of the first member and the second member being used as a rotor, the rotor being made rotatable relative to the stator, characterized in that
(1) the first member includes a first surface which opposes to the second member, the first surface being provided with a plurality of poles which are arranged in the circumferential direction along the first surface and which extend in the axial direction, the first surface being formed therein with a plurality of slots in such a manner that each of the slots is placed between the poles which are adjacent to each other, two of the slots between which a plurality of other slots are placed are made to accommodate therein each of circumferentially arranged plural coils upon winding thereof which are to be grouped for constituting plural phases,
(2) the second member includes a second surface which opposes to the first member, the second surface being provided thereon with a plurality of circumferentially arranged magnetic material pieces which are magnetically independent with each other,
(3) when the magnetic material piece is opposed to the plural poles which are consecutive in the circumferential direction, the consecutive poles are magnetically coupled, the poles and the magnetic material piece constitute a closed magnetic circuit when each of the phases is energized to generate a magnetic flux, thereby producing a rotation torque,
(4) in each of the grouped phases, different coils which are accommodated in the slots which are next to another are to be supplied with currents of same polarity.

15. A motor as set forth in claim 14, wherein ends of the coils which are different in phase intersect on the pole such that the coils accommodated in the slots which are next to another are made the same in current supply polarity.

16. A motor as set forth in claim 14, wherein each of the phases is constituted by grouping the coils the number of which is even.
